(19) United States
(12) Patent Application Publication
(10) Pub. No.: US 2026/0208824 A1
(43) Pub. Date: Jul. 23, 2026

(54) SNOWMOBILE

(71) Applicant: Polaris Industries Inc., Medina, MN (US)

(72) Inventors: David W. CHRISTIAN, St. Francis, MN (US); Michael A. HEDLUND, Roseau, MN (US); Darren J. HEDLUND, Roseau, MN (US); Colton J. ROSS, Warroad, MN (US); Jeffrey A. EATON, Roseau, MN (US); Jesse J. LAUGEN, Roseau, MN (US); Matthew J. PRUSAK, Salol, MN (US); Timothy W. STENLUND, Minneapolis, MN (US); Joseph D. THARALDSON, Taylors Falls, MN (US); Lucas R. SALFER, Salol, MN (US); James P. PALMINTERI, Salol, MN (US); Cory L. HUOT, Roseau, MN (US)

(21) Appl. No.: 19/455,335

(22) Filed: Jan. 21, 2026

Related U.S. Application Data
(60) Provisional application No. 63/748,357, filed on Jan. 22, 2025.

(51) Int. Cl. B62M 27/02; B60K 11/04; B60T 1/00

(52) U.S. Cl. CPC B62M 27/02; B60K 11/04; B60T 1/00; B62M 2027/023; B62M 2027/028

(57) ABSTRACT

The present disclosure relates to a brake cooling system integrated with the jack shaft of a snowmobile in which cooling is provided through fluid communication with an interior tunnel region of a tunnel frame. A drive shaft mounting configuration adapted to facilitate the installation and removal of snowmobile drive shafts is also disclosed. A further aspect relates to snowmobile chassis configurations adapted to promote modularity between different snowmobile styles and/or to enhance powertrain mounting. A speed sensing system as well as engine mounting configurations are also disclosed.

### CROSS-REFERENCE TO RELATED APPLICATIONS

The present application claims priority from U.S. Provisional Patent Application No. 63/748,357, filed Jan. 22, 2025, the complete disclosure of which expressly incorporated by reference herein.

### TECHNICAL FIELD

The present disclosure relates generally to vehicles. More particularly, the present disclosure relates to off-road vehicles such as snowmobiles.

### BACKGROUND

The present disclosure relates generally to off-road vehicles such as snowmobiles. Snowmobiles are available for various applications and riding styles. Example applications/riding styles include mountain (e.g., deep snow), trail, sport utility and crossover. A typical snowmobile includes a chassis, a front suspension for supporting the chassis relative to skis, a rear suspension for supporting the chassis relative to a track, a powertrain for driving rotation of the track and a steering system for allowing an operator to turn the skis. Example documents disclosing snowmobiles include U.S. Pat. Nos. 8,490,731; 9,446,810; 7,353,898; 7,870,920; 11,653,112; 11,286,019; and US Patent Publication No. 2013/0032419, the disclosures of which are hereby expressly incorporated by reference herein in their entireties.

### SUMMARY

One aspect of the present disclosure relates to braking systems for vehicles such as snowmobiles having configurations to enhance effective brake cooling.

Another aspect of the present disclosure relates to drive shaft mounting configurations adapted to facilitate the installation and removal of snowmobile drive shafts.

A further aspect of the present disclosure relates to snowmobile chassis configurations adapted to promote modularity between different snowmobile styles and/or to enhance powertrain mounting.

A further aspect of the present disclosure relates to a double-shear attachment configuration for securing a snowmobile engine mount to a snowmobile chassis.

A further aspect of the present disclosure relates to a speed sensing configuration for a snowmobile that integrates a speed sensor into a cover plate configured to rotatably support an end of a snowmobile drive shaft.

A variety of additional inventive aspects will be set forth in the description that follows. The inventive aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a front, left perspective view of a snowmobile;

FIG. 2 is a rear, left perspective view of the snowmobile of FIG. 1;

FIG. 3 is a side view of the snowmobile of FIG. 1;

FIG. 4 is a front, right perspective view of a snowmobile chassis in accordance with the principles of the present disclosure;

FIG. 5 is a front, left perspective view of the snowmobile chassis of FIG. 4;

FIG. 6 is a left side view of the snowmobile chassis of FIG. 4;

FIG. 7 is a right side view of the snowmobile chassis of FIG. 4;

FIG. 8 is a top view of the snowmobile chassis of FIG. 4;

FIG. 9 is a front view of the snowmobile chassis of FIG. 4;

FIG. 10 is a perspective view of a braking system in accordance with the principles of the present disclosure integrated with the chassis of FIG. 4;

FIG. 11 is a top view of the braking system of FIG. 10;

FIG. 12 is a perspective view of the braking system of FIG. 10 viewed from above a tunnel frame of the chassis of FIG. 4; a heat exchanger that forms a top of a tunnel frame has been removed to better show an inboard side of the braking system that is exposed to an interior tunnel region of the tunnel frame;

FIG. 13 depicts braking system of FIG. 10 viewed from within the interior tunnel region of the tunnel frame to show the inboard side of the braking system;

FIG. 14 is a longitudinal cross-sectional view cut through a jack shaft on which the braking system of FIG. 10 is installed;

FIG. 15 is another longitudinal cross-sectional view cut through the jack shaft on which the braking system of FIG. 10 is installed, the interior tunnel region as well as the inboard side of the braking system are visible;

FIG. 16 is a cross-sectional view cut vertically through the braking system of FIG. 10;

FIG. 17 is another cross-sectional view cut vertically through the braking system of FIG. 10;

FIG. 18 is a perspective view of an outboard side of a right-side bulkhead plate of the chassis of FIG. 4;

FIG. 19A is an outboard side view of the right-side bulkhead plate of FIG. 18;

FIG. 19B is an outboard side view of an alternative right-side bulkhead plate;

FIG. 20 is a perspective view of an inboard side of the right-side bulkhead plate of FIG. 18;

FIG. 21 is an inboard side view of the right-side bulkhead plate of FIG. 18;

FIG. 22 is an enlarged perspective view of a portion of the inboard side of the right-side bulkhead plate of FIG. 18;

FIG. 23 is a cross-sectional view depicting a double-shear connection configuration for attaching an engine mount to the right-side bulkhead plate of FIG. 18;

FIG. 24 is a perspective view of the double-shear connection configuration of FIG. 23;

FIG. 25 is another perspective view of the double-shear connection configuration of FIG. 23;

FIG. 26 is an outboard perspective view of a left-side bulkhead plate of the chassis of FIG. 4 with a drive shaft mounting cover attached to the left-side bulkhead plate;

FIG. 27 is another outboard perspective view of the left-side bulkhead plate and drive shaft mounting cover of FIG. 26;

FIG. 28 is an enlarged perspective view of the outboard side of the drive shaft mounting cover of FIGS. 26 and 27;

FIG. 29 is a perspective view from beneath the tunnel frame showing an inboard side of the drive shaft mounting cover of FIG. 28;

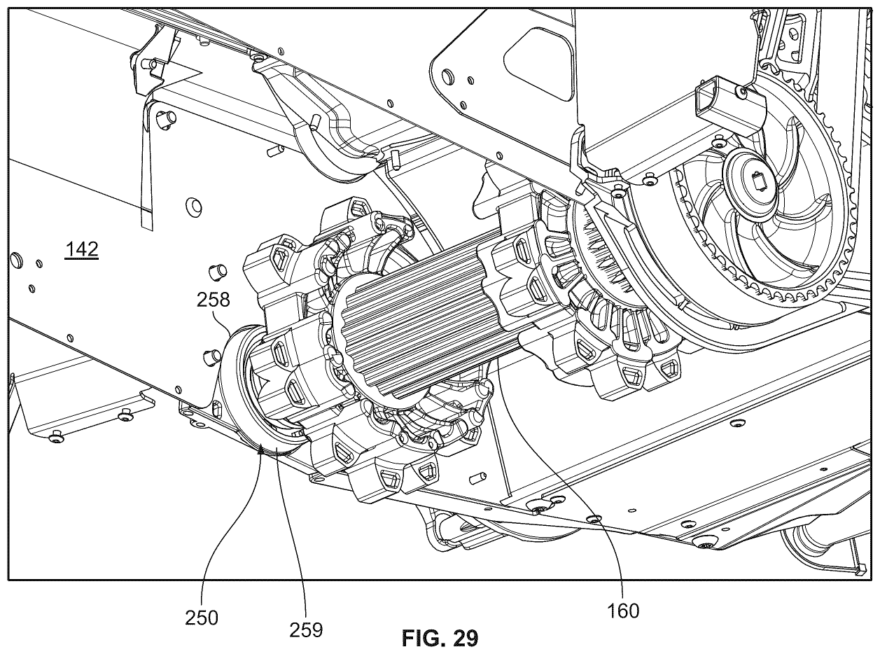

FIG. 30 is an enlarged perspective view from beneath the tunnel frame showing an inboard side of the drive shaft mounting cover of FIG. 28;

FIG. 31A is a perspective view of the inboard side of the drive shaft mounting cover of FIG. 28 with the drive shaft removed, the depicted drive shaft mounting cover is adapted to provide a drive shaft position suitable for a first style of snowmobile such as a mountain snowmobile;

FIG. 31B is a perspective view of the inboard side of an alternative drive shaft mounting cover with the drive shaft removed, the depicted drive shaft mounting cover is adapted to provide a drive shaft position suitable for a second style of snowmobile such as a trail snowmobile;

FIG. 32 is a perspective view showing the outboard side of a left-side bulkhead plate of the chassis of FIG. 4;

FIG. 33 is an enlargement depicting engine mount attachment locations of the left-side bulkhead plate of FIG. 32;

FIG. 34 is an enlargement of an outboard bearing pocket of the left-side bulkhead plate of FIG. 32;

FIG. 35 is an enlargement of a drive shaft cover mounting location of the left-side bulkhead plate of FIG. 32;

FIG. 36 is a top, inboard perspective view of the left-side bulkhead plate of FIG. 32;

FIG. 37 is an inboard side view of the left-side bulkhead plate of FIG. 32;

FIG. 38 is a cross-sectional view cut longitudinally through a drive shaft mounted to the chassis of FIG. 4; the drive shaft is shown in an installed position within the chassis;

FIG. 39 is a cross-sectional view cut longitudinally through the drive shaft of FIG. 38 with the drive shaft shown in an axially shifted position with respect to the chassis;

FIG. 40 is a cross-sectional view cut longitudinally through the drive shaft of FIGS. 38 and 39 with the drive shaft shown lowered from the chassis;

FIG. 41 is a perspective view depicting an engine mount attached to a first engine mount attachment location of the left-side bulkhead plate of FIG. 32;

FIG. 42 is a perspective view depicting an engine mount attached to a second engine mount attachment location of the left-side bulkhead plate of FIG. 32;

FIG. 43 is a perspective view of an outboard side of the drive shaft mounting cover with a drive shaft speed sensor mounted on the outboard side of the drive shaft mounting cover;

FIG. 44 is a transparent view of the drive shaft mounting cover depicting the drive shaft speed sensor mounted to the drive shaft mounting cover and sensor pickups provided at an end of the drive shaft located within the drive shaft mounting cover adjacent the drive shaft speed sensor;

FIG. 45 is another view depicting the sensor pickups at the end of the drive shaft;

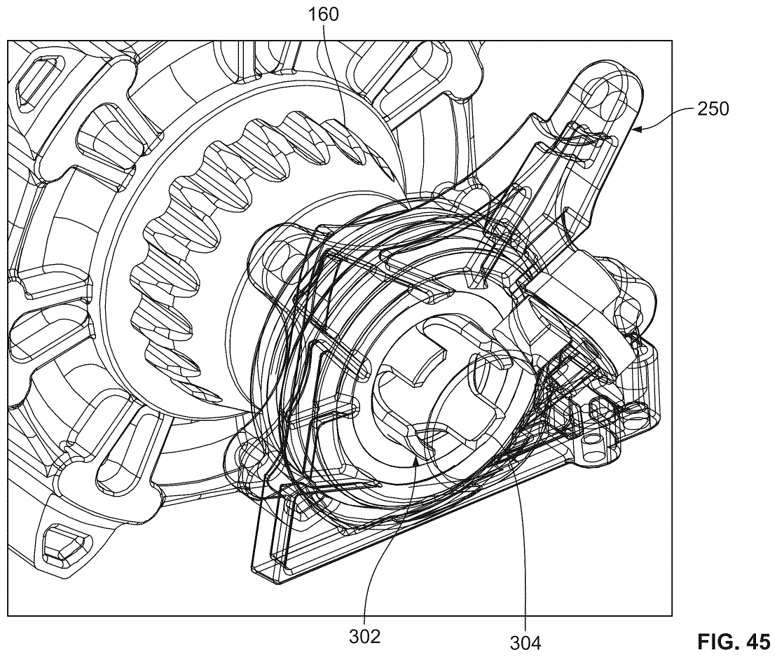

FIG. 46 is a front, left side perspective view of an over-structure of the chassis of FIG. 4;

FIG. 47 is a front, right side perspective view of the over-structure of FIG. 46;

FIG. 48 is a rear perspective view of the over-structure of FIG. 46;

FIG. 49 is a top view of the over-structure of FIG. 46;

FIG. 50 is a perspective view depicting fuel tank retention mounts integrated into the rear support members of the over-structure of FIG. 46;

FIG. 51 is a rear, outboard view of a left-rear support member of the over-structure of FIG. 46;

FIG. 52 is a rear, inboard view of the left-rear support member of the over-structure of FIG. 46;

FIG. 53 is a rear, outboard view of the right-rear support member of the over-structure of FIG. 46;

FIG. 54 is a rear, inboard view of the right-rear support member of the over-structure of FIG. 46;

FIG. 55 depicts the left-rear support member of the over-structure coupled to a rear of the left-side bulkhead plate and the right-rear support member of the over-structure coupled to a rear of the right-side bulkhead plate;

FIG. 56 depicts an electronic controller mounting location integrated into the underside of an over-structure hub located at a top of the over-structure;

FIG. 57 depicts a housing of an electronic controller fastened to the electronic controller mounting location of FIG. 56;

FIG. 58 depicts the over-structure hub with a steering shaft rotatably mounted at a rear steering shaft mounting location of the over-structure hub;

FIG. 59 depicts the over-structure hub of FIG. 58 with the steering shaft removed and a brake line routed through a rear brake line opening defined by the over-structure hub adjacent the rear steering shaft mounting location;

FIG. 60 is another view of the over-structure hub of FIG. 58 with the brake line routed through the rear brake line opening;

FIG. 61 is a further view of the over-structure hub of FIG. 58 with the brake line routed through the rear brake line opening;

FIG. 62 is another view of the over-structure of FIG. 58 with the brake line routed through the rear brake line opening;

FIG. 63 is a perspective view illustrating a steering shaft rotatably mounted at a front steering shaft mounting location of the over-structure hub and a brake line routed through a front brake line opening of the over-structure hub;

FIG. 64 depicts a connection interface between the left-rear support member, the left-side bulkhead plate and a left-side running board bracket;

FIG. 65 is another view of the connection interface of FIG. 64;

FIG. 66 depicts a connection interface between the right-rear support member, the right-side bulkhead plate and a right-side running board bracket;

FIG. 67 is another view of the connection interface of FIG. 66;

FIG. 68 is a perspective view of a running board assembly.

### DETAILED DESCRIPTION

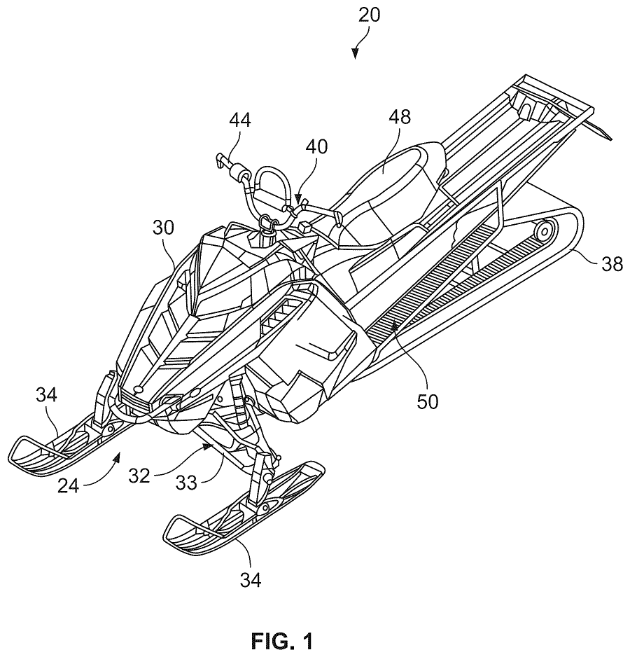

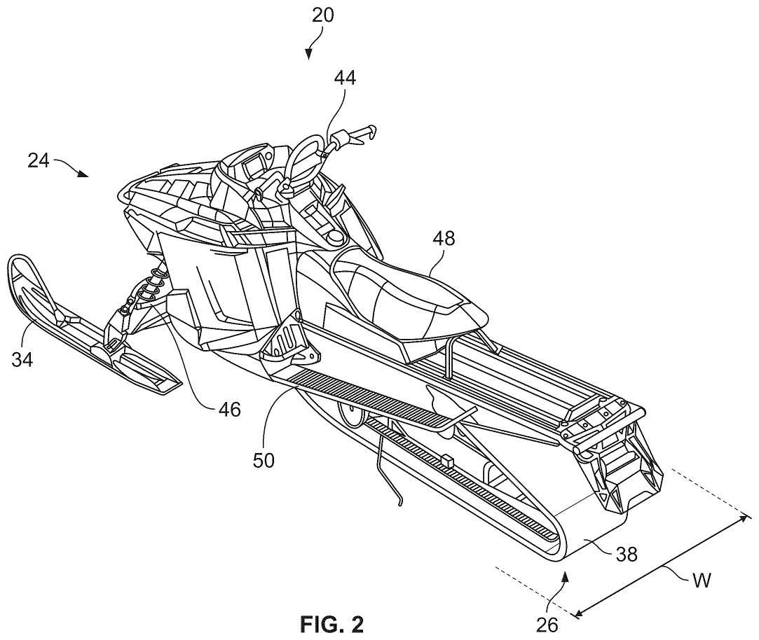

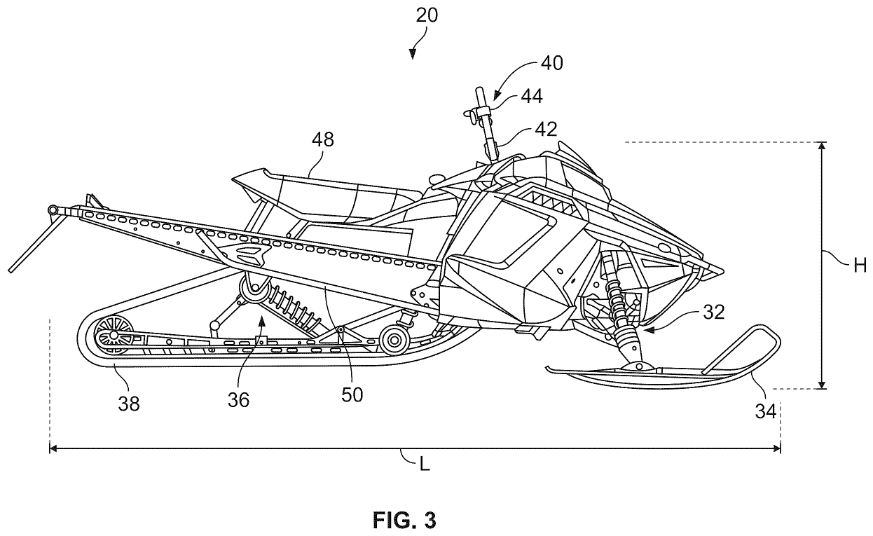

FIGS. 1-3 depict an example snowmobile 20 having a base construction into which structural aspects of the present disclosure can be incorporated. The snowmobile 20 includes a chassis. A front suspension 32 supports the chassis relative to front skis 34 and a rear suspension 36 supports the chassis relative to a track 38. The front suspension 32 can include control arms 33 and shock absorbing/damping structures. The rear suspension 36 can also include shock absorbing/damping structures. A powertrain is supported by the chassis. The powertrain drives rotation of the track 38 to provide propulsion of the snowmobile 20. The snowmobile includes a steering system 40 for allowing an operator to steer the snowmobile 20. The steering system 40 can include a steering shaft 42 and a handlebar 44 that is manually turned to rotate the steering shaft 42. Steering links 46 are operatively coupled to the steering shaft 42 and to knuckles corresponding to the skis 34 such that the skis 34 are turned in response to rotation of the steering shaft 42 by the handlebar 44. A seat 48 is supported on the chassis behind the handlebar 44 and running board assemblies 50 are coupled to the chassis on opposite sides of the seat 48. An outer shell/body can at least partially cover the chassis, powertrain and other components.

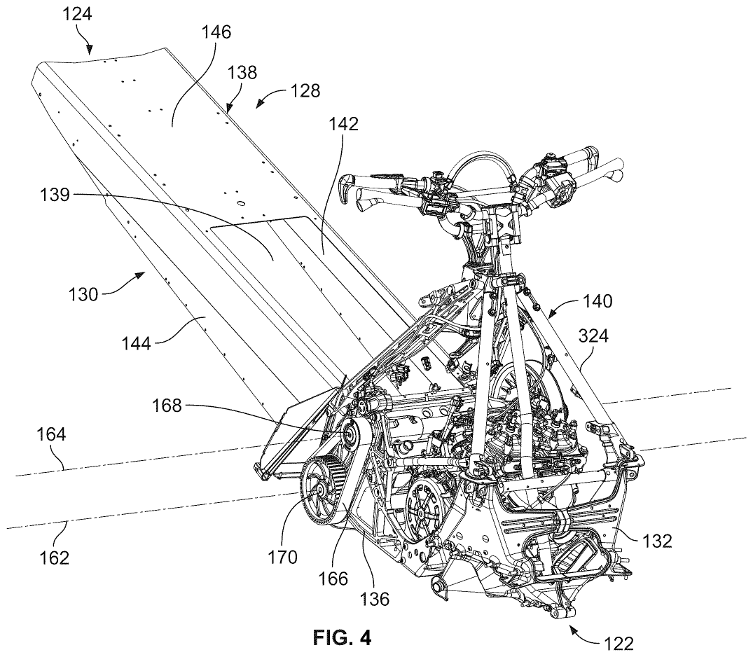

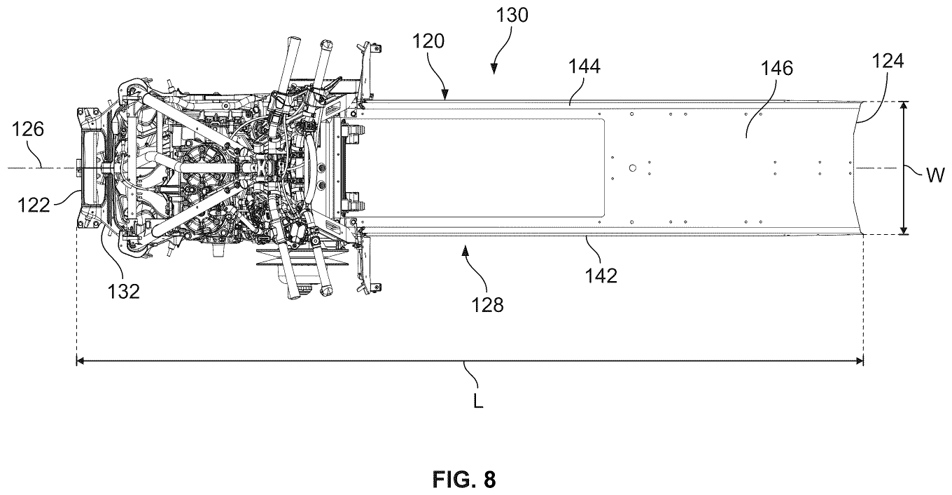

FIGS. 4-9 depict a snowmobile chassis 120 in accordance with the principles of the present disclosure that can be used in a snowmobile such as the snowmobile 20 of FIGS. 1-3. The chassis 120 has a length L (see FIG. 8) that extends from a front 122 to a rear 124 of the chassis 120. The chassis 120 defines a central longitudinal axis 126 that extends centrally through the chassis 120 along the length L. The chassis 120 includes a left side 128 and a right side 130.

Referring still to FIGS. 4-9, the chassis 120 includes a front suspension frame 132 positioned at the front 122 of the chassis 120. The front suspension frame 132 is configured to be coupled to a front suspension (e.g., front suspension 32) adapted for supporting the chassis 120 relative to a pair of skis (e.g., skis 34).

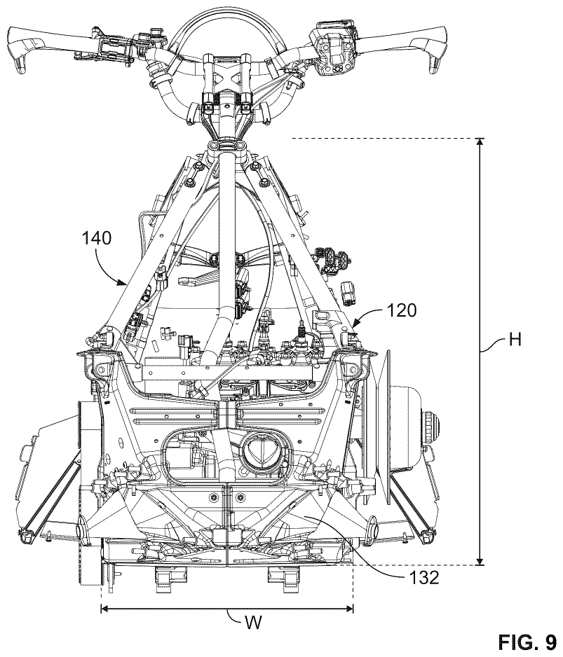

The chassis 120 also includes a left-side bulkhead plate 134 and a right-side bulkhead plate 136 respectively positioned at the left and right sides 128, 130 of the chassis 120 at an intermediate location along the length L of the chassis 120. The left-side and right-side bulkhead plates 134, 136 extend rearwardly with respect to the front suspension frame 132. The chassis 120 also includes a tunnel frame 138 that extends from the rear 124 of the chassis 120 to the left-side and right-side bulkhead plates 134, 136. The tunnel frame 138 defines an interior tunnel region 139. The chassis 120 further includes an over-structure 140 position generally above the left-side and right-side bulkhead plates 134, 136. A width W (see FIGS. 8 and 9) of the chassis 120 extends between the left side 128 and the right side 130 of the chassis 120. A height H (see FIG. 9) of the chassis 120 extends between a bottom of the tunnel frame 138 to a top of the over-structure 140. The orientations of the length L, width W and height H of the chassis 120 correspond to the orientations of the length, width and height of a snowmobile into which the chassis 120 is incorporated.

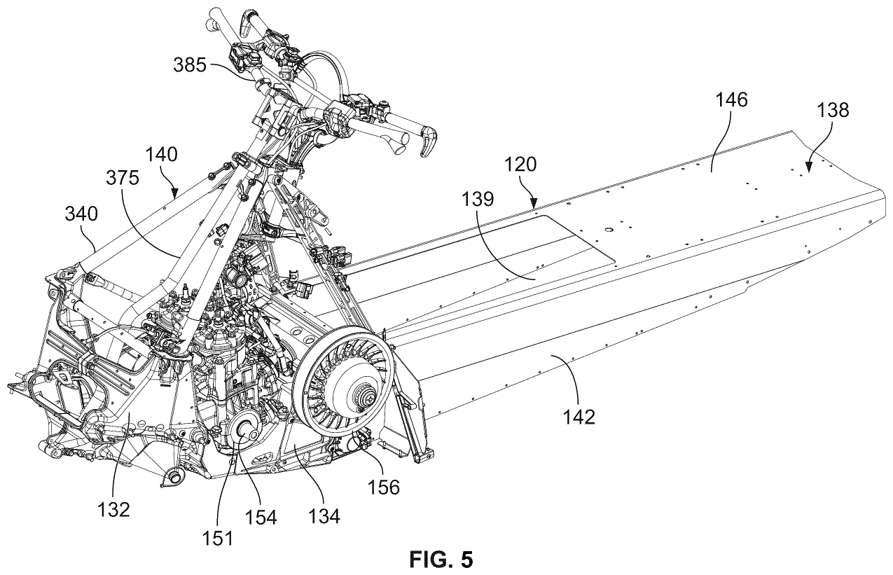

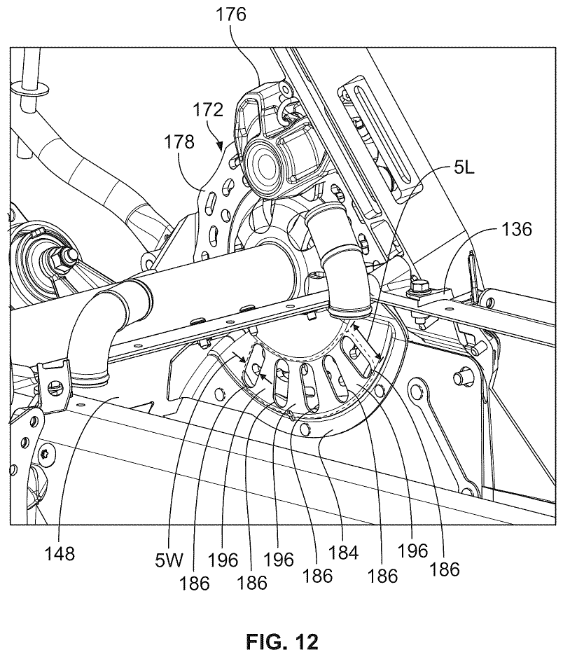

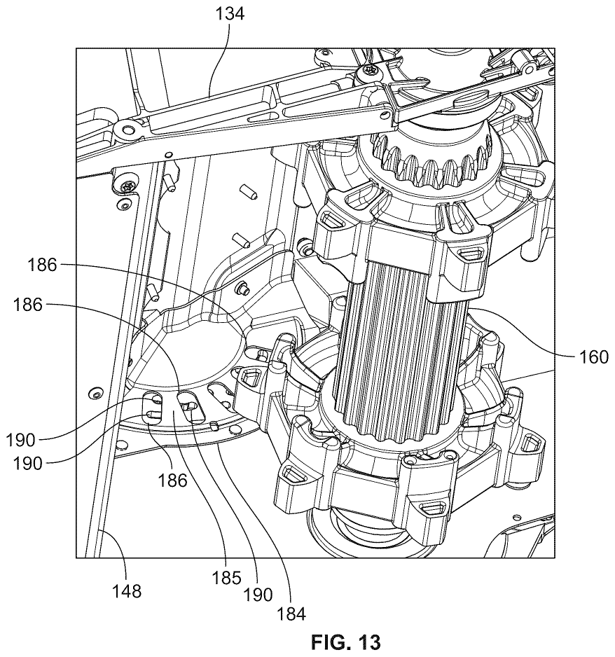

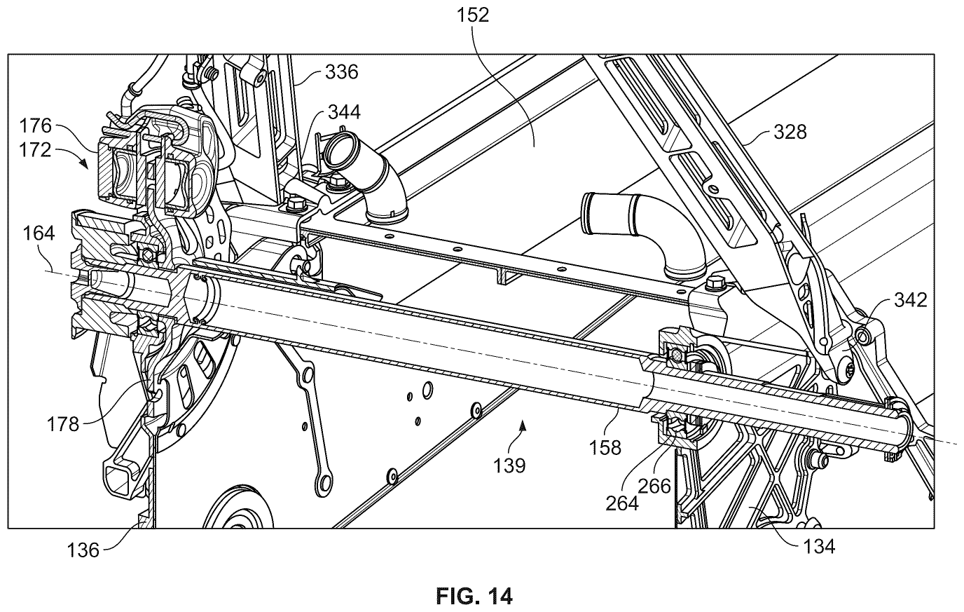

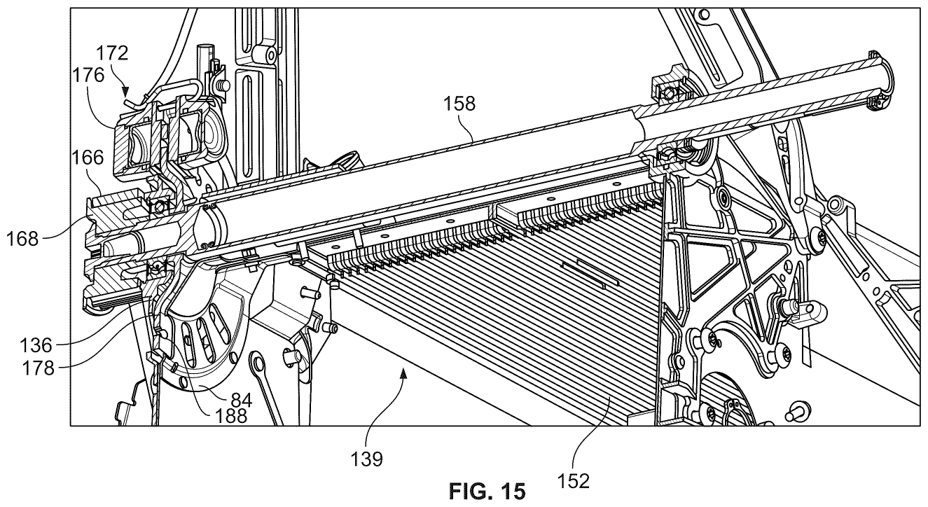

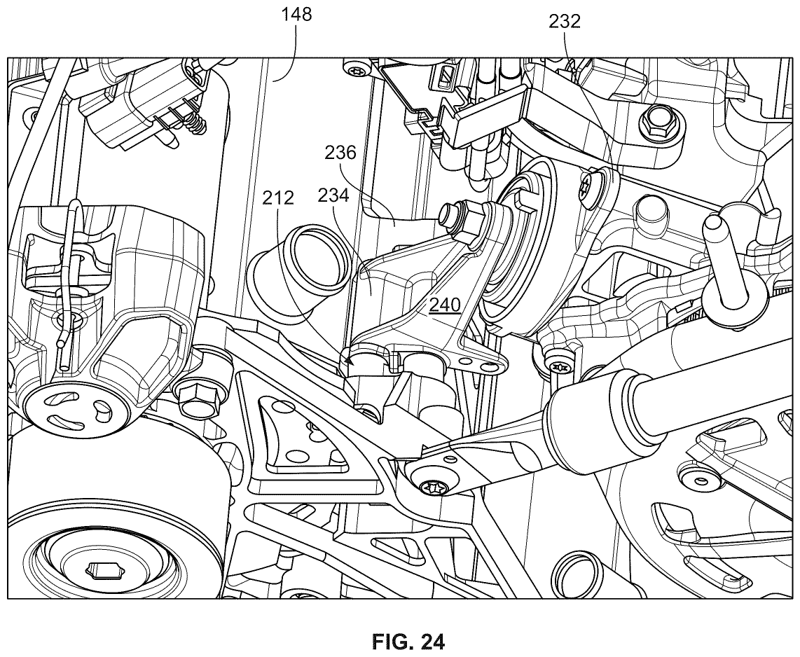

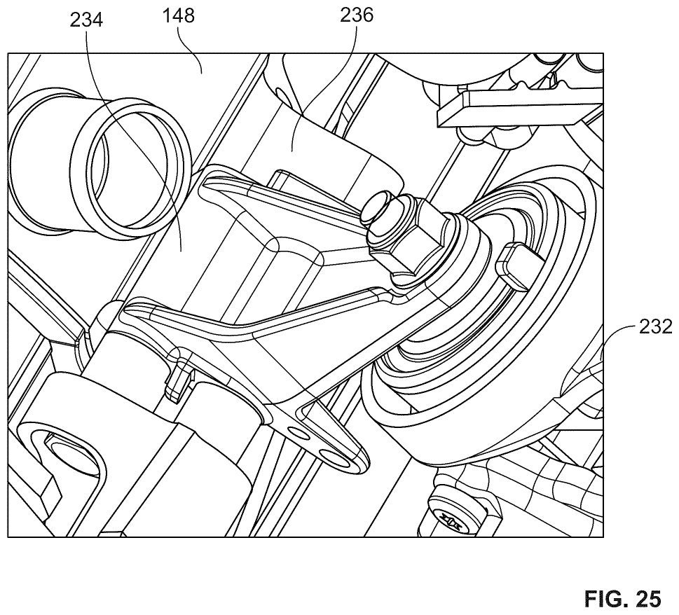

Referring to FIGS. 4 and 5, the tunnel frame 138 includes a left wall 142, a right wall 144 and a top wall 146 that extends between the left and right walls 142, 144. The interior tunnel region 139 is defined between the left and right walls 142, 144 beneath the top wall 146. In certain examples, portions of the top wall 146 are defined by heat exchangers such as a first heat exchanger 148 (see FIGS. 12, 13, 24 and 25) positioned at a front end of the tunnel frame 138 and a second heat exchanger 152 (see FIGS. 14 and 15) defining a portion of the top wall 146. It will be appreciated that engine coolant of an engine cooling system is circulated through the heat exchangers 148, 152 to provide cooling of the engine coolant. In many of the views, the second heat exchanger 152 has been removed to improve the visibility of other components of the snowmobile. It will be appreciated that a track (e.g., track 38) can be positioned at least partially with the interior tunnel region 139 and coupled to the tunnel frame 138 by a rear suspension (e.g., rear suspension 36). As depicted, the left-side bulkhead plate 134 overlaps a forward portion of the left wall 142 of the tunnel frame 138 and the right-side bulkhead plate 136 overlaps a forward portion of the right wall 144 of the tunnel frame 138. Fasteners can be used to secure the left-side bulkhead plate 134 and the right-side bulkhead plate 136 to the tunnel frame 138. A seat (e.g., seat 48) can be mounted above the top wall 146.

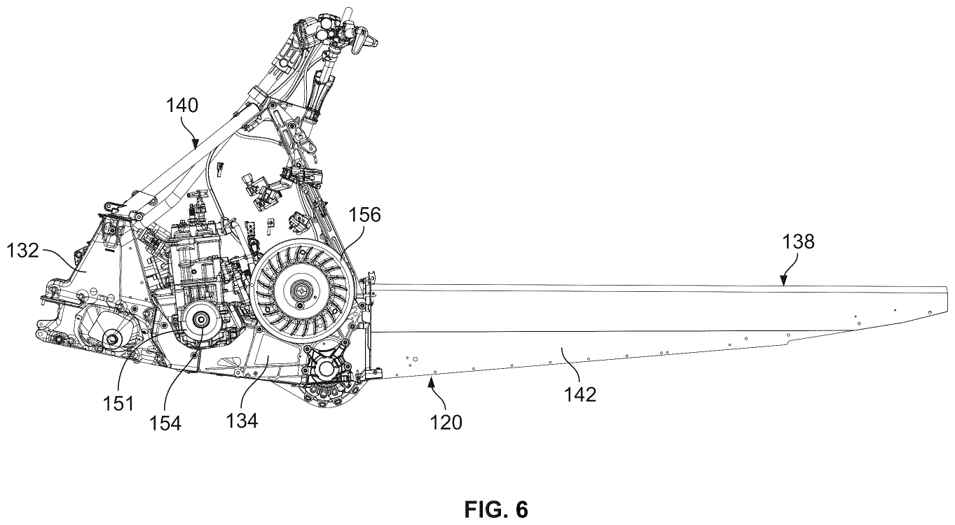

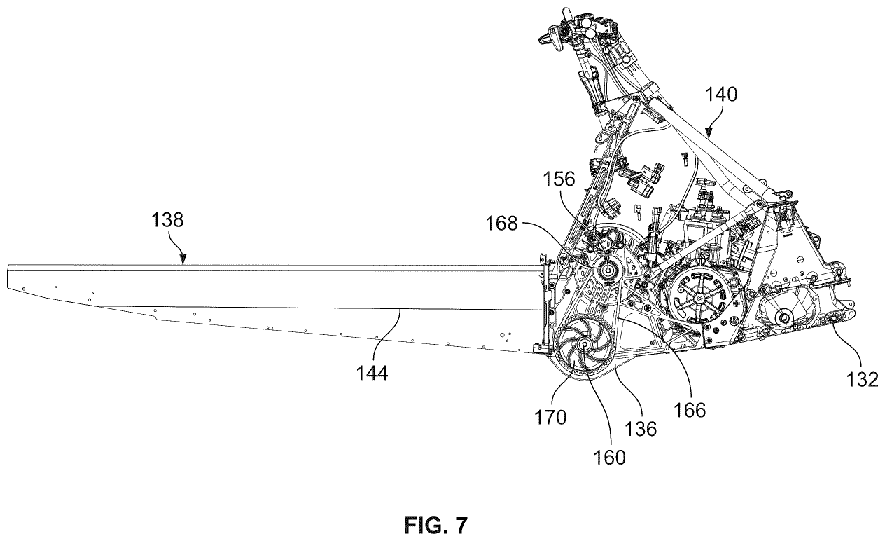

Referring still to FIGS. 4-9, at least a portion of a snowmobile powertrain is mounted in a region generally between the left-side bulkhead plate 134 and the right-side bulkhead plate 136. The powertrain generally includes an engine 151 having a crankshaft 154, a transmission 156 (e.g., a continuously variable transmission (CVT); portions of which are depicted), a jack shaft 158 and a drive shaft 160. The transmission 156 can be located at the left side of the chassis 120 as shown at FIGS. 5 and 6). The drive shaft 160 extends across the width W of the chassis 120 between the left-side and right-side bulkhead plates 134, 136 and is rotatable about a drive shaft axis 162 that extends lengthwise through the drive shaft 160. The drive shaft 160 is configured to interface with the track (e.g., via a track drive sprocket) to drive rotation of the track relative to the tunnel frame 138. The jack shaft 158 also extends across the width of the chassis between the left-side and right-side bulkhead plates 134, 136. The jack shaft 158 is rotatable about a jack shaft axis 164 that extends longitudinally through the jack shaft 158. The drive shaft 160, the jack shaft 158 and the crankshaft 154 are preferably generally parallel to each other. A continuous drive element 166 (e.g., a belt or chain) can be used to transfer torque from the jack shaft 158 to the drive shaft 162. As depicted the continuous drive element 166 is a toothed belt routed about sprockets 168, 170 respectively mounted at ends of the jack shaft 158 and drive shaft 160 (see FIGS. 4 and 7 where the drive element 166 and sprockets 168, 170 are located at an outboard side of the right-side bulkhead plate 136). In operation of the powertrain, torque generated by the engine 151 is transferred from the crankshaft 154 through the transmission 156 to the jack shaft 158 to drive rotation of the jack shaft 158 about the jack shaft axis 164. Torque from the jack shaft 158 is transferred to the drive shaft 160 via the continuous drive element 166 to drive rotation of the drive shaft 160 about the drive shaft axis 162. Engagement between the drive shaft 160 and the track drives rotation of the track relative to the tunnel frame 138 such that the track provides propulsion of the snowmobile.

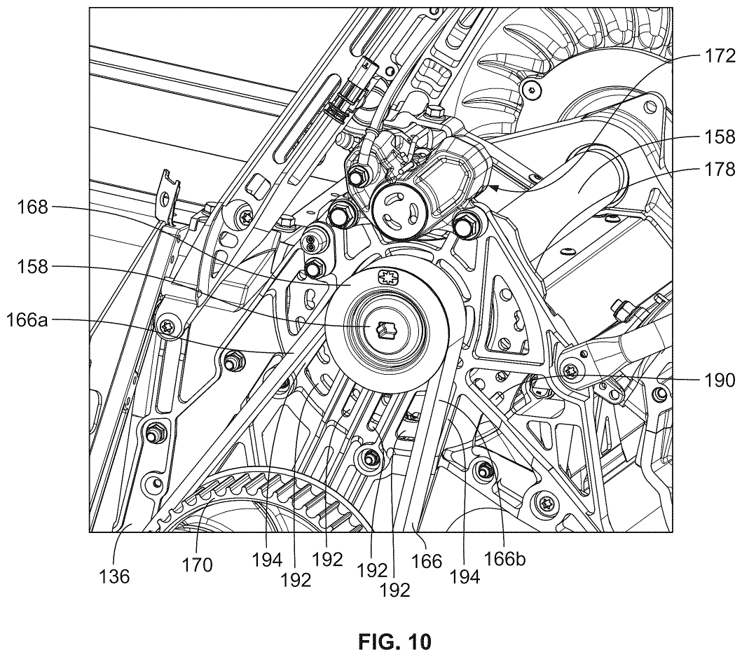

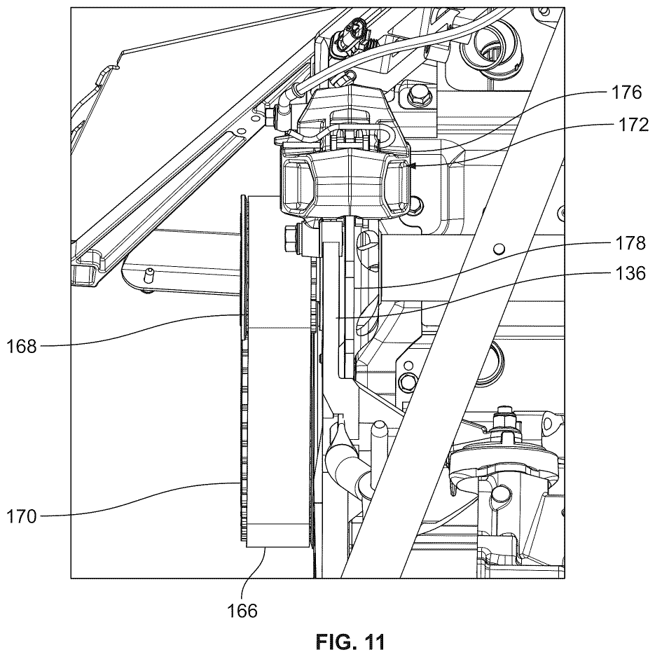

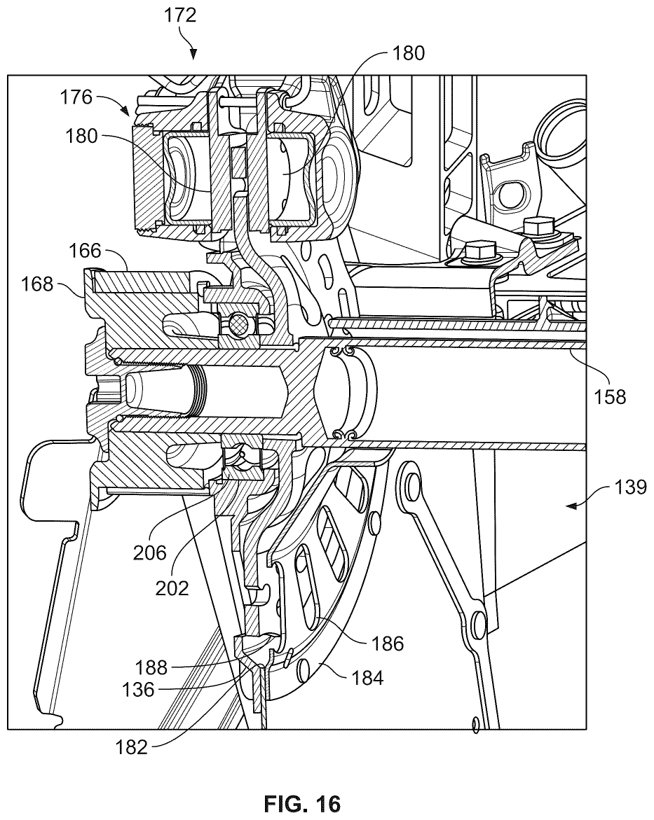

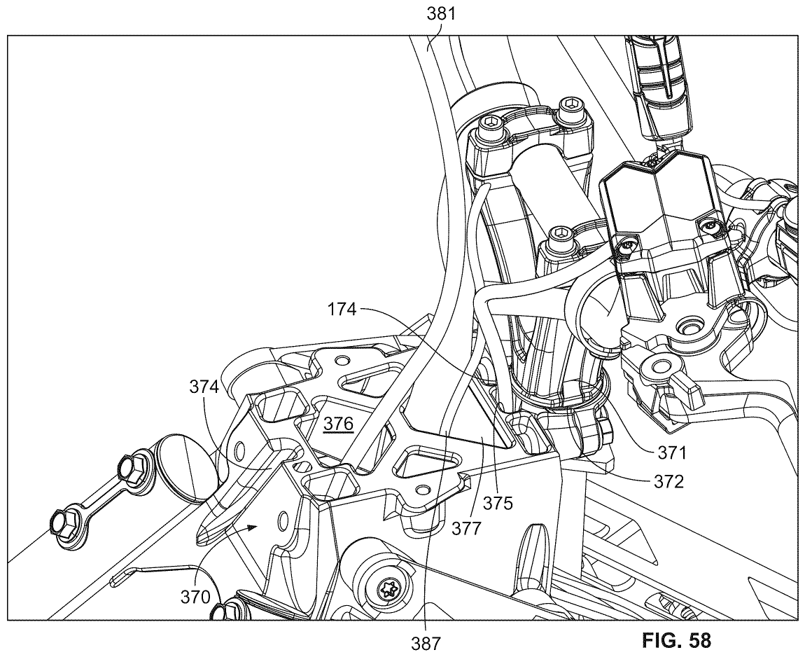

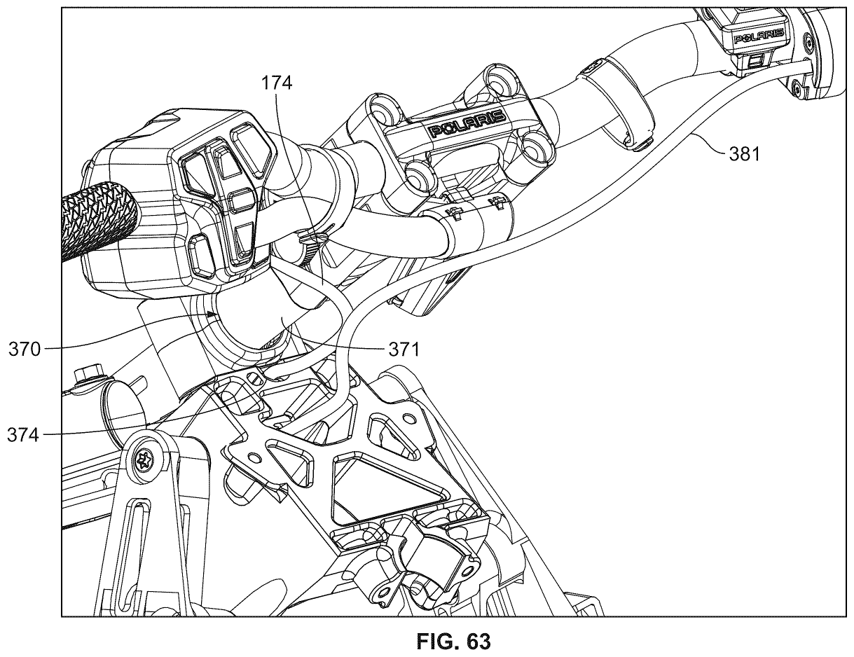

A braking system 172 (see FIGS. 10-17) is integrated with the jack shaft 158 to provide snowmobile braking. The braking system can be a hydraulic braking system. A brake lever coupled to a brake line 174 (see FIGS. 58 and 63) can be mounted on a handlebar of the snowmobile to allow an operator to actuate the braking system 172. The braking system 172 includes a caliper 176 and a braking disc 178. The caliper 176 includes brake pads 180 between which the braking disc 178 can be compressed/clamped (e.g., via hydraulic pressure) to provide braking. Actuation of the caliper 176 by the operator can be provided through the brake lever and brake line 174. A torque transferring relationship (e.g., splined, hex, etc.) exists between the jack shaft 158 and the braking disc 178 such that the braking disk 178 is rotatable with the jack shaft 158 about the jack shaft axis 164. As best shown at FIGS. 12-17, the braking disc 178 is exposed to the interior tunnel region 139 to provide effective cooling of the braking disc 178. As depicted, a first portion (e.g., a lower portion such as a lower half) of the braking disc 178 is exposed to the interior tunnel region 139 as the braking disc 178 rotates. It will be appreciated that as the track is rotated relative to the tunnel frame 138, the track generates airflow within the interior tunnel region 139 which is directed towards and across the first portion of the braking disc 178 to provide cooling of the braking disc 178. Additionally, as the track rotates relative to the tunnel frame 138, the track carries snow/ice that are directed into contact with the first portion of the braking disk 178 to provide additional cooling of the braking disc 178.

Referring still to FIGS. 12-17, the tunnel frame 138 defines a frame opening 182 for exposing the first portion of the braking disk 178 to the interior tunnel region 139. It be appreciated that the frame opening 182 can be defined through a side (e.g., the right wall 144) and/or through a top (e.g., the top wall 146) of the tunnel frame 138. In the depicted example, a flow control cover 184 is attached to the tunnel frame 138 and functions to block a portion of the frame opening 182. The flow control cover 184 includes a wall 185 that defines a plurality of flow control openings 186 that in cooperation with the frame opening 182 expose the lower portion of the braking disc 178 to the interior tunnel region 139. The flow control openings 186 can be sized and arranged to prevent excessive snow, ice or debris from being directed against the braking disc 178. As depicted at FIGS. 14-17, the lower portion of the braking disk 178 is located within a disk cooling region 188 defined between the flow control cover 184 and an inboard side of the right-side bulkhead plate 136. In the depicted example, and inboard side of the lower portion of the braking disc 178 opposes the wall 185 of the flow control cover 184 and an outboard side of the lower portion of the braking disc 178 opposes the inboard side of the right-side pocket plate 136. The braking disc 178 rotates through the disk cooling region 188 as the jack shaft 158 is rotated about the jack shaft axis 164. As depicted, the disk cooling region 188 is positioned immediately outside the interior tunnel region 139 and is partially separated from the interior tunnel region 139 by the flow control cover 184. The flow control openings 186 provide fluid communication between the interior tunnel region 139 and the disk cooling region 188 thereby exposing the disk cooling region 188 and the lower portion of the braking disc 178 to the interior tunnel region 139. The flow control openings 186 are defined through a portion of the flow control cover 184 that opposes the inboard side of the lower portion of the braking disc 178 and expose the inboard side of the lower portion of the braking disc 178. When the track is rotated, the track causes air, snow and ice from within the interior tunnel region to flow through the flow control openings 186 into the disk cooling region 188 and into contact with the lower portion of the braking disc 178.

In other examples, the disk cooling region 188 can be within the interior tunnel region 139. In other examples, flow control openings can be defined directly through a wall (e.g., wall 144) of the tunnel frame 138.

The right-side bulkhead plate 136 supports the jack shaft 158 and the drive shaft 160. The drive element 166 is a belt that is located at an outboard side of the right-side bulkhead plate 136. The drive element 166 is routed about the sprockets 168, 170 that are located outboard with respect to the right-side bulkhead plate 136. The braking disc 178 is located inboard with respect to the right-side bulkhead plate 136. The flow control cover 184, the braking disc 178 and the right-side bulkhead plate 136 cooperate to define one or more flow paths from the interior tunnel region 139 (e.g., through the frame opening 182) to the outboard side of the right-side bulkhead plate 136. For example, the braking disc 178 defines disc through-openings 190 and the right-side bulkhead plate 136 defines side openings 192. The frame opening 182, the flow control openings 186, the disc through-openings 190 and the side openings 192 cooperate to define one or more flow paths that extend from the interior tunnel region 139 to the outboard side of the right-side bulkhead plate 136 for allowing air flow generated by rotation of the track to flow from the interior tunnel region 139 across/through the lower portion of the braking disc 178 to the outboard side of the right-side bulkhead plate 136. Thus, air flowing into the disk cooling region 188 from the interior tunnel region 139 can exit the disc cooling region 186 in an outboard direction through the right-side bulkhead plate 136 via the disc through-openings 190 and the side openings 192.

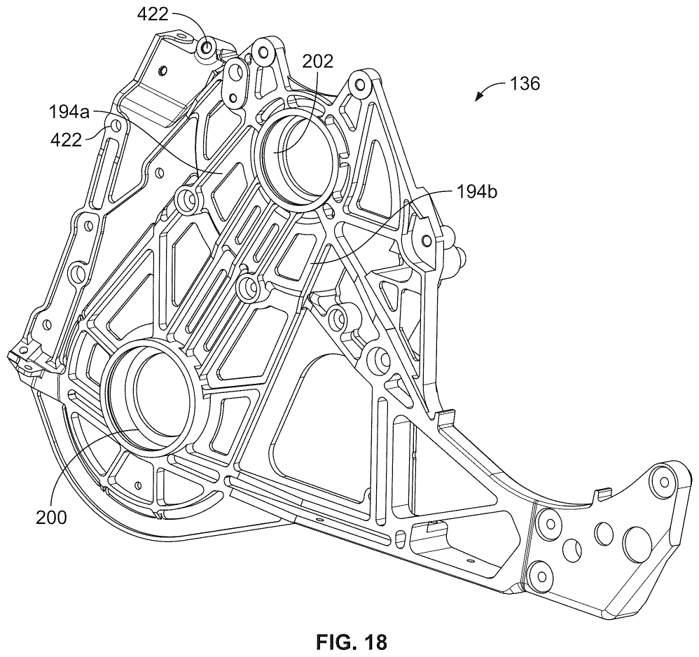

In certain examples, the right-side bulkhead plate 136 can provide heat shielding of the drive element 166 with respect to heat generated at the braking disc 178. For example, the right-side bulkhead plate 136 can include shielding portions 194 (see FIGS. 10 and 18) positioned between the drive element 166 and the braking disc 178 for shielding the drive element 166 from heat generated at the braking disc 178. It will be appreciated that the braking disc 178 is located inboard of the shielding portions 194 and the drive element 166 is located outboard of the shielding portions 194. The side openings 192 can be offset with respect to the drive element 166. In the depicted example, a plurality (e.g., four) of the side openings 192 are located between first and second ones 194a, 194b of the shielding portions 194. The shielding portions 194a, 194b respectively align with/oppose corresponding portions 166a, 166b of the drive element 166

Referring to FIG. 12, the flow control openings 186 include a plurality of slots that are spaced-apart with respect to each other in a circumferential orientation with respect to the jack shaft axis 164. The slots are separated by slats 196 of the wall of the flow control cover 184. The slots are elongated in a radial direction with respect to the jack shaft axis 164. In one example, the slots have slot lengths SL in the range of 17-21 millimeters (mm) and slot widths SW in the range of 10-14 mm. In one example, the flow control cover 184 defines a pass-through region including a boundary B that bounds the flow control openings 186 and the slats 196. In certain examples, the pass-through region is 30-70% open. In other examples, the pass-through region is 40-60% open.

It will be appreciated that since the braking disc 178 rotates about the jack shaft axis 164 with the jack shaft 158, the entire circumference of the braking disc 178 moves through the disc cooling region 188 to provide cooling. However, at any given moment, only about the lower half of the braking disc is actually within the disk cooling region 188 and exposed to the flow of air and snow from the interior tunnel region 139.

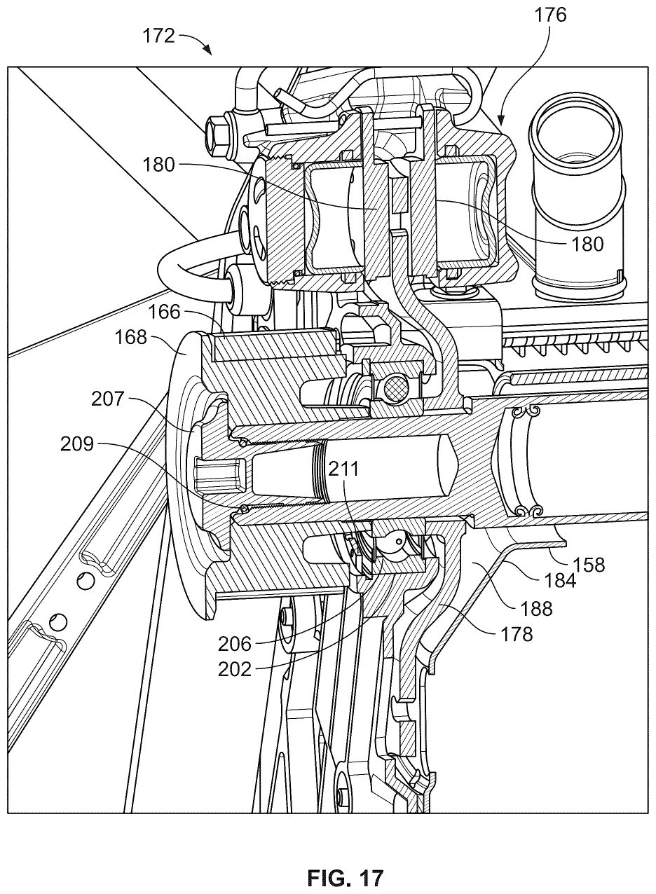

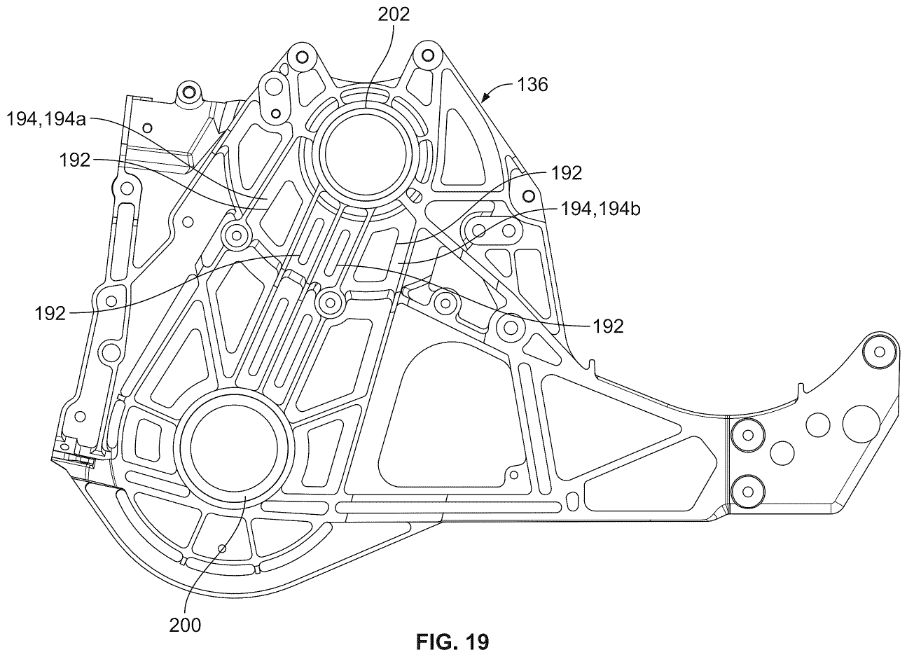

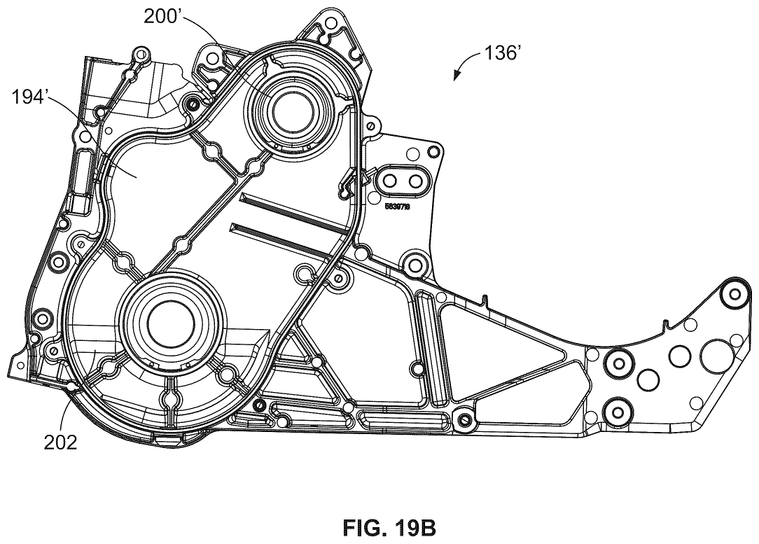

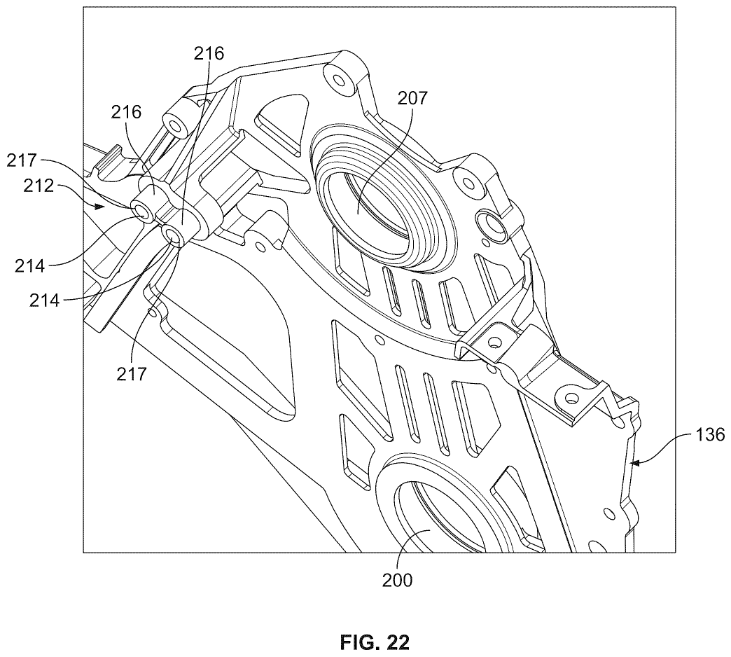

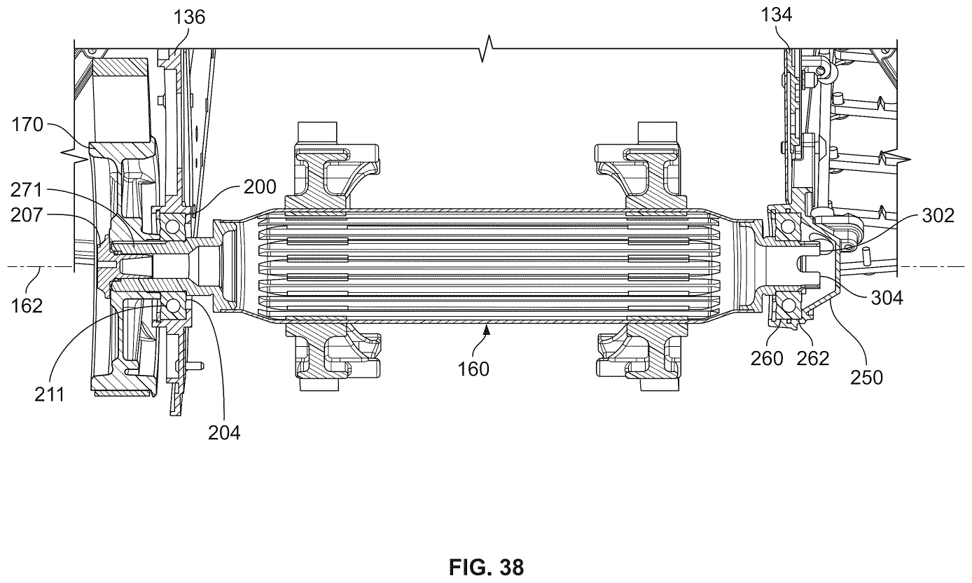

The chassis 120 has a configuration adapted to provide precise positioning and alignment of components of the powertrain. The chassis 120 also include a modular configuration that allows selected components of the chassis to be shared between different chassis corresponding to different snowmobile styles (e.g., mountain and trail). In the depicted example, the right-side bulkhead plate 136 (see FIGS. 18-22) has a one-piece cast construction (e.g., a monolithic construction). In one example, the right-side bulkhead plate 136 can be manufactured of cast aluminum. The right-side bulkhead plate 136 defines a first bearing pocket 200 through which the drive shaft 160 extends and a second bearing pocket 202 through which the jack shaft 158 extends. A first bearing 204 is mounted in the first bearing pocket 200 (see FIG. 38) supporting the drive shaft 160 for rotation about the drive shaft axis 162. A second bearing 206 is mounted in the second bearing pocket 202 (see FIG. 17) for supporting the jack shaft 158 for rotation about the jack shaft axis 164. The bearings 204, 206 can include inner races that engage (e.g., are pressed on) the shafts 160, 158 and outer races that engage (e.g., are pressed in) the cylindrical portions of the right-side bulkhead plate 136 which define the first and second bearing pockets 200, 202. Ball bearings can be provided between the inner and outer races. The bearing pockets 200, 202 are defined at the outboard side of the right-side bulkhead plate 136 (see FIGS. 18 and 19). The drive shaft 160 and the jack shaft 158 extend through the right-side bulkhead plate 136 with ends of the shafts 158, 160 projecting outwardly from the outboard of the right-side bulkhead plate 136 (see FIGS. 17 and 38). The sprockets 168, 170 are mounted in torque transmitting relation (e.g., via mating splined interfaces) on the ends of the shafts 158, 160. End caps 207 are threaded into the outboard ends of the shafts 158, 160 to provide axial retention of the sprockets 168, 170 on the shafts 158, 160. Elastomeric gaskets 209 can be compressed within the ends of the shafts 158, 160 by the end caps 207 to resist unthreading of the end caps 207 from within the ends of the shafts 158, 160. Snap rings 211 can assist in retaining the bearings 204, 206 in their corresponding bearing pockets 200, 202 (e.g., when the sprockets 168, 170 are removed). When the sprockets 168, 170 are secured on the shafts 158, 160, tightening of the end caps 207 can cause the inner races of the bearings to be compressed between the sprockets 168, 170 and the right-side bulkhead plate 136.

It will be appreciated that the cast configuration of the right-side bulkhead plate 136 provides a precise center-to-center spacing between the center of the jack shaft 158 and the center of the drive shaft 160. Since the center-two-center spacing between the jack shaft 158 and the drive shaft 160 can vary from snowmobile style to snowmobile style, it will be appreciated that the depicted right-side bulkhead plate 136 can be a custom part that that is customized for a particular snowmobile style. For example, the depicted right-side bulkhead plate 136 as shown in FIG. 19A can correspond to a first style of snowmobile (e.g., a mountain snowmobile) and can provide a center-to-center jack shaft to drive shaft spacing customized for the first style of snowmobile and a modified right-side bulkhead plate 136′ as shown in FIG. 19B can correspond to a second style of snowmobile (e.g., a trail snowmobile) and can provide a different center-to-center jack shaft to drive shaft spacing that is customized for the second style of snowmobile. In the modified right-side bulkhead plate 136′, the first bearing pocket 200′ containing the first bearing 204 supporting the drive shaft can be positioned relative to the second bearing pocket 202 containing the second bearing 206 supporting the jack shaft in a different position from the first bearing pocket 200 in right side bulkhead plate 136. Thus, the modified right-side bulkhead plate 136′ provides the different center-to-center spacing for the second style of snowmobile while providing a consistent position for the second bearing pocket 202 when compared to right-side bulkhead plate 136. Thus, in manufacturing, different versions of right-side bulkhead plates such as 136 and 136′ can be cast and stocked corresponding to the different styles of snowmobiles desired to be manufactured. Other features of the right-side bulkhead plate 136 such as shielding portions 194 can be provided in modified form in the modified right-side bulkhead plate 136′, for example having a single shielding element 194′. In some examples, some features of the right-side bulkhead plate 136 can be omitted in modified right-side bulkhead plate 136′, such as some of the openings 192.

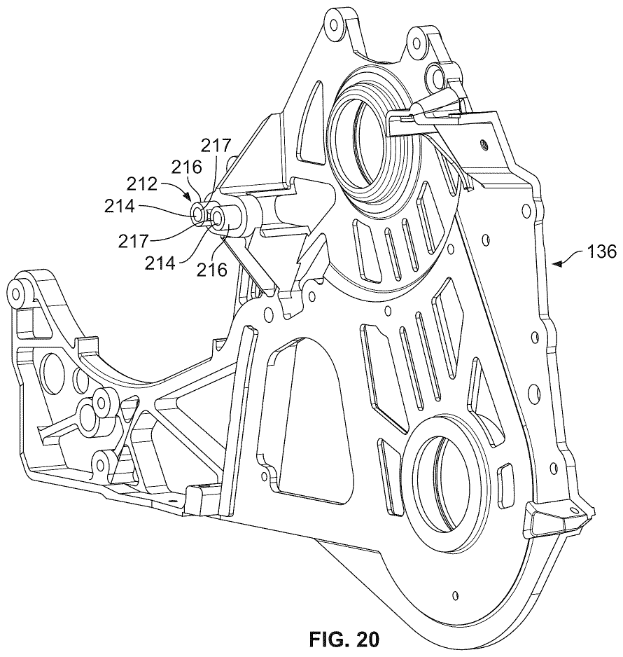

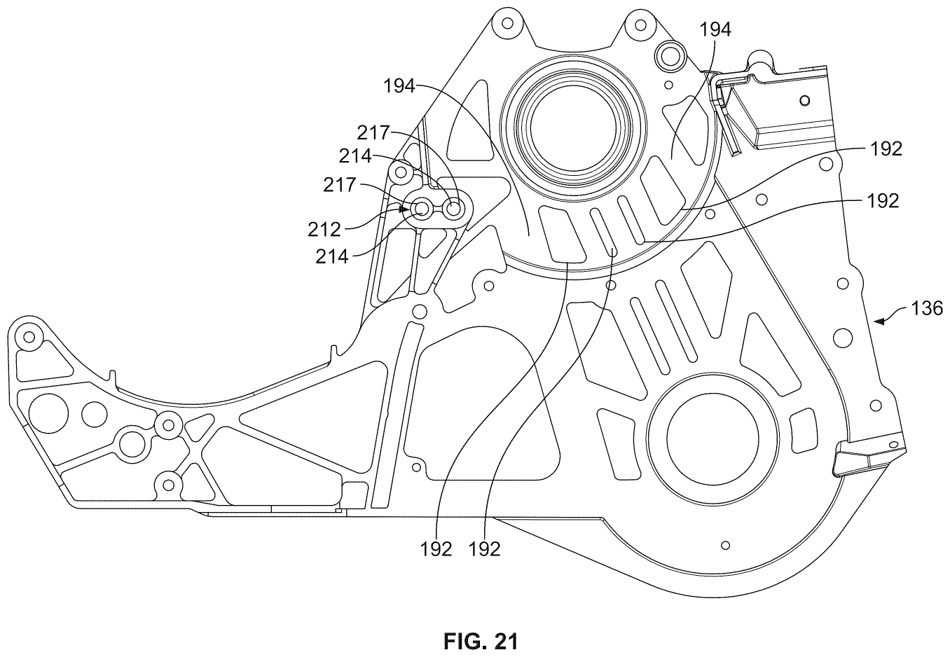

The right-side bulkhead plate 136 also includes an engine mount attachment location 212 (see FIG. 20). In the depicted example, the engine mount attachment location 212 includes at least one fastener opening 214 which extends through the right-side bulkhead plate 136 in an inboard/outboard orientation. As depicted, two parallel fastener openings 214 are defined through inboard projections 216 (see FIG. 21). The inboard projections 216 have clamping surfaces 217 that face in an inboard direction. By coordinating the positioning of the jack shaft 158, the drive shaft 160 and the engine 151 with a single unitary piece such as the right-side bulkhead plate 136, the relative positioning of the jack shaft 158, the drive shaft 160 and the crankshaft 154 can be precisely established and maintained. In the depicted example, the jack shaft 158, the drive shaft 160 and the crankshaft 154 are generally parallel and are arranged in a generally triangular configuration when viewed from the side of the snowmobile.

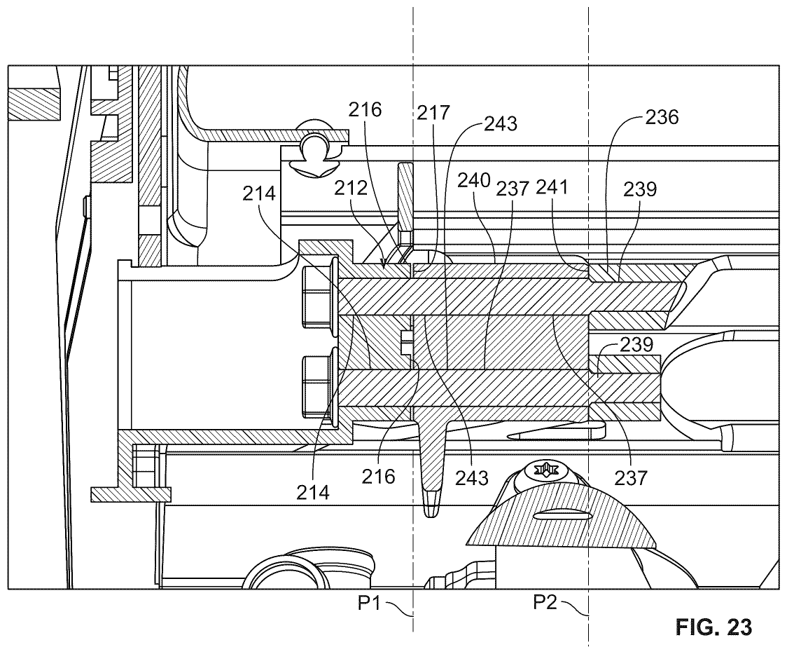

FIGS. 23-25 depict a double-shear attachment configuration for coupling of an engine mount 230 to the chassis 120. The engine mount 230 includes a first connection interface 232 for fastening the engine mount 230 to the engine 151 and a second connection interface 234 for fastening the engine mount 230 to the chassis 120. The engine mount 230 includes a damping structure integrated into the engine mount 230 between the first and second connection interfaces 232, 234. The second connection interface 234 attaches to the chassis 120 at the engine mount attachment location 212 of the right-side bulkhead plate 136. The second connection interface 234 also attaches to the chassis 120 at a mounting projection 236 that is unitary with the first heat exchanger 148 and includes a clamping surface 241. The second connection interface 234 includes fastener openings 237 and the mounting projection 236 includes fastener openings 239 that extend through the clamping surface 241. The second connection interface 234 is provided as part of a mounting link 240 of the engine mount 230. In a mounted configuration, the mounting link 240 fits between the clamping surfaces 217 of the inboard projections 216 and the clamping surface 241 of the mounting protection 236. Additionally, the fastener openings 214 coaxially align with the fastener openings 237 the of mounting link 240 as well as the fastener openings 239 of the mounting projection 236. Fasteners such as bolts 243 can be installed through the coaxially aligned openings 214, 237, 239 and tightened to clamp the mounting link 214 between the clamping surfaces 217 of the inboard projections 216 and the clamping surface 241 of the mounting projection 236. The openings 239 can be internally threaded (e.g., tapped) such that threaded ends of the bolts 243 can be threaded in the opening 239 to provide clamping at first and second shear planes P1, P2. Enhanced support is provided by opposition to relative movement provided between the two opposite sides of the mounting link 214 and the clamping surfaces 217, 241. The configuration provides clamping areas along both the first shear plane P1 and the second shear plane P2 for resisting movement between the engine mount 230 and the chassis 120. The first shear plane P1 corresponds to the contact/clamping interface between clamping surfaces 271 and a first side of the mounting link 241 and the second shear plane P2 corresponds to the contact interface between the clamping surfaces 241 and an opposite side of the mounting link 241.

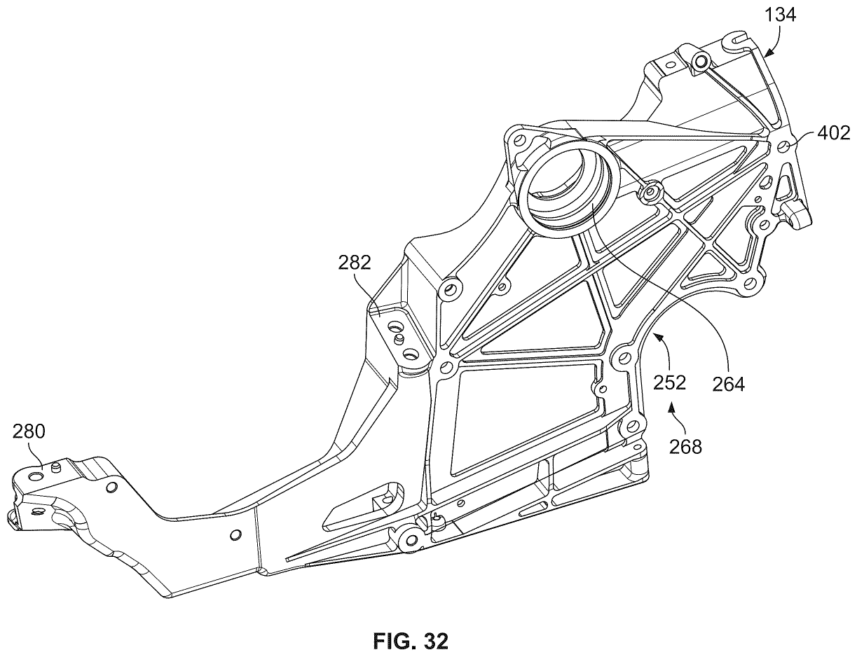

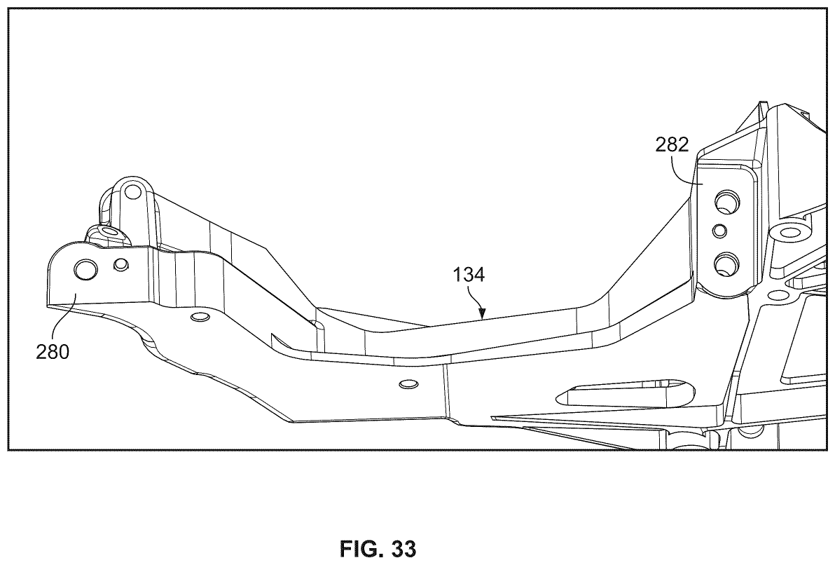

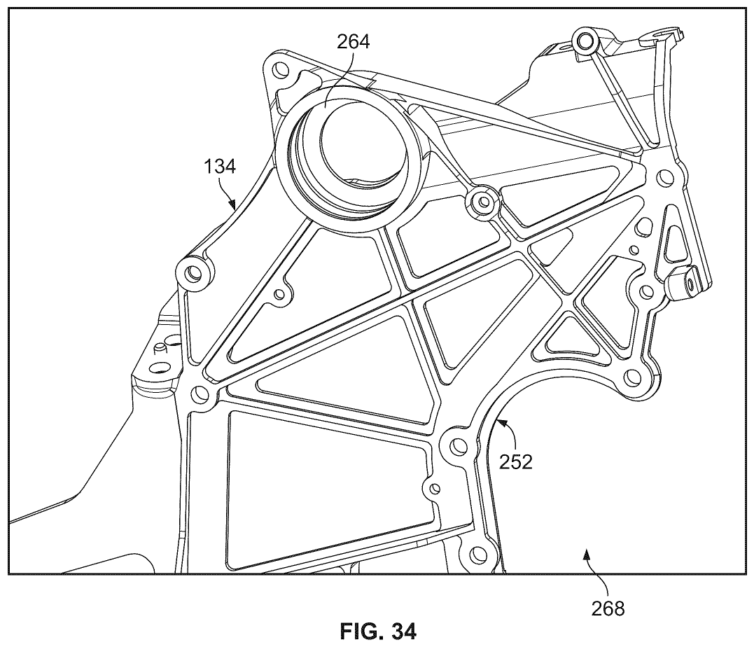

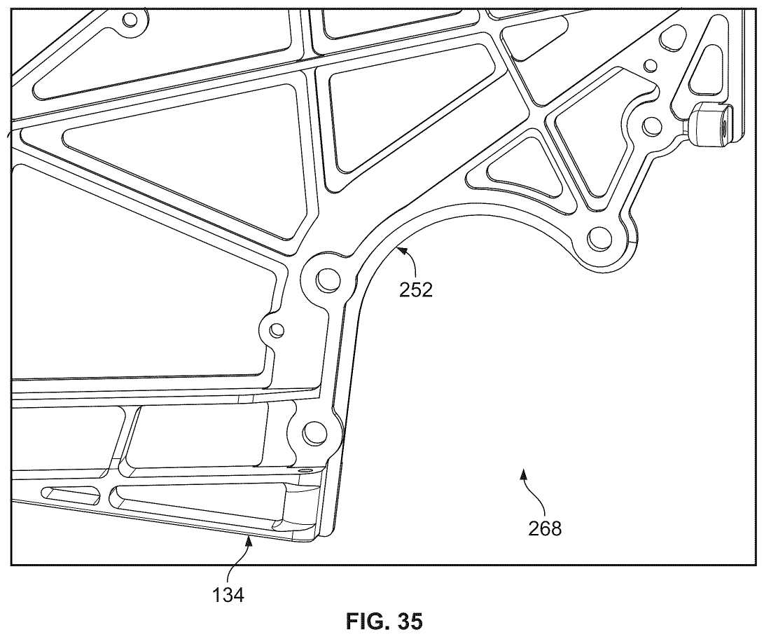

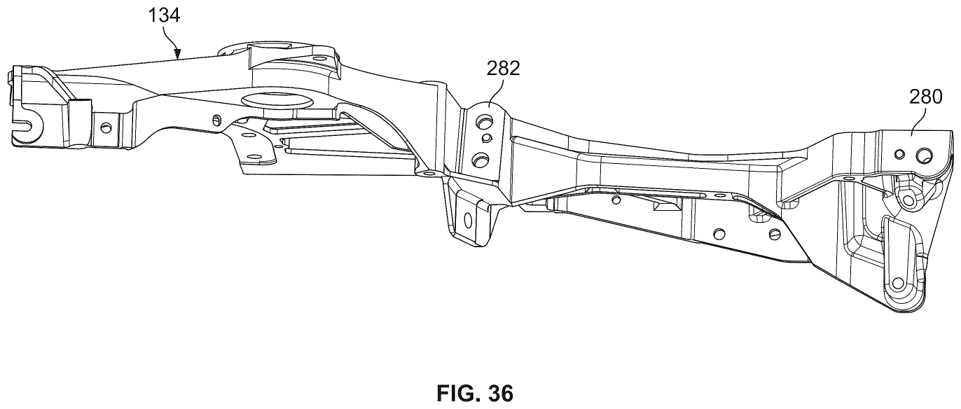

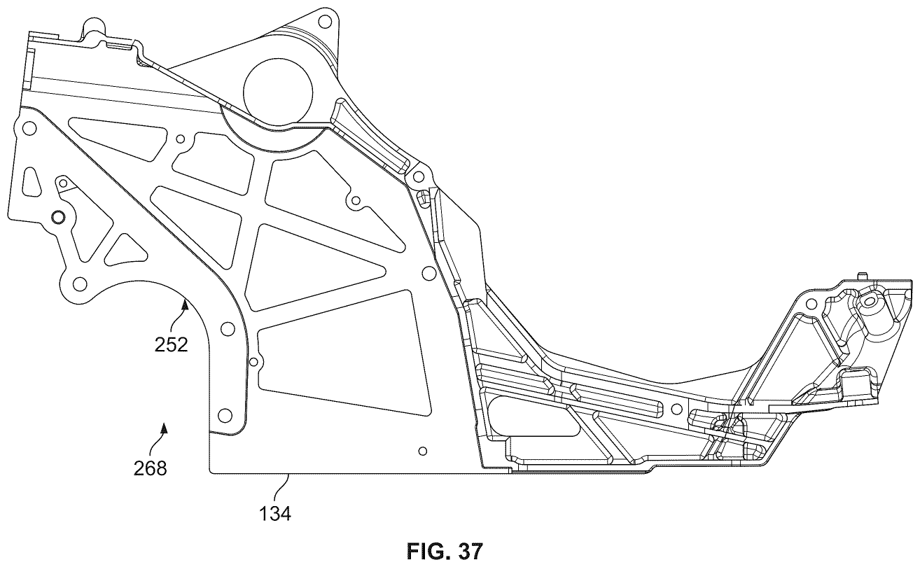

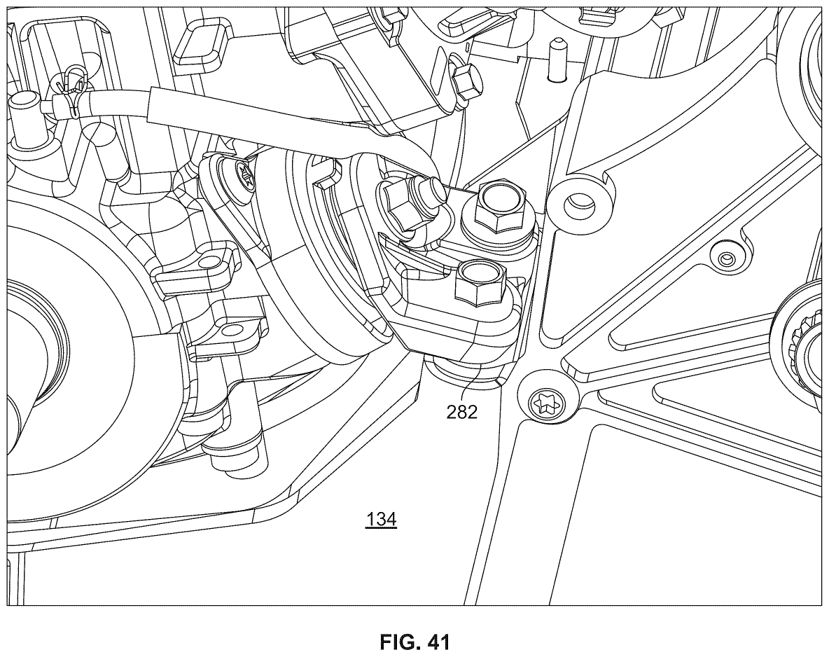

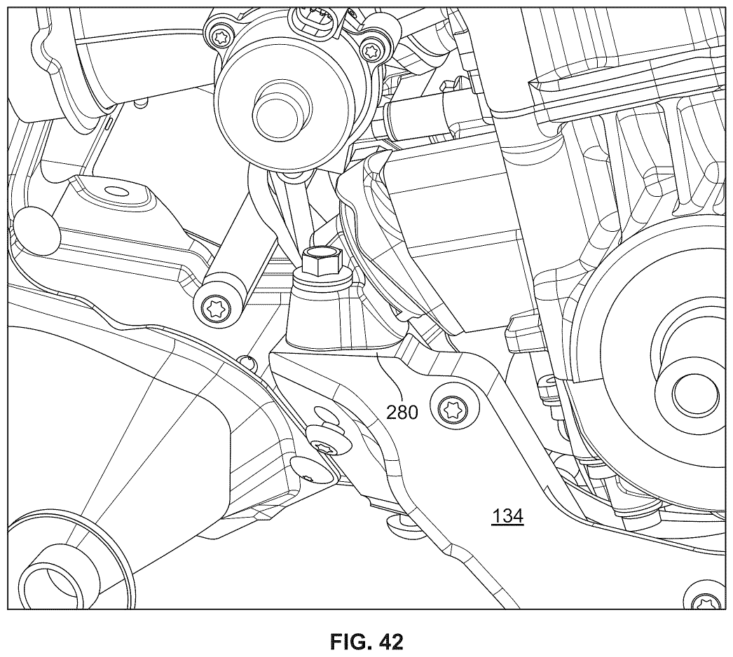

The left-side bulkhead plate 134 (see FIGS. 32-37) also can have a one-piece cast construction. In one example, the left-side bulkhead plate 134 has a cast aluminum construction. The left-side bulkhead plate 134 and the right-side bulkhead plate 136 are separated generally by a width of the snowmobile and are generally parallel with respect to each other. The left-side bulkhead plate 134 includes a forward engine mount attachment location 280 (see FIG. 42) and a rearward engine mount attachment location 282 (see FIG. 41). The forward engine mount attachment location 280 and the rearward engine mount attachment location 282 assist in precisely positioning the center line (e.g., axis of rotation) of the crankshaft 154 at a predetermined location relative to the left-side bulkhead plate 134.

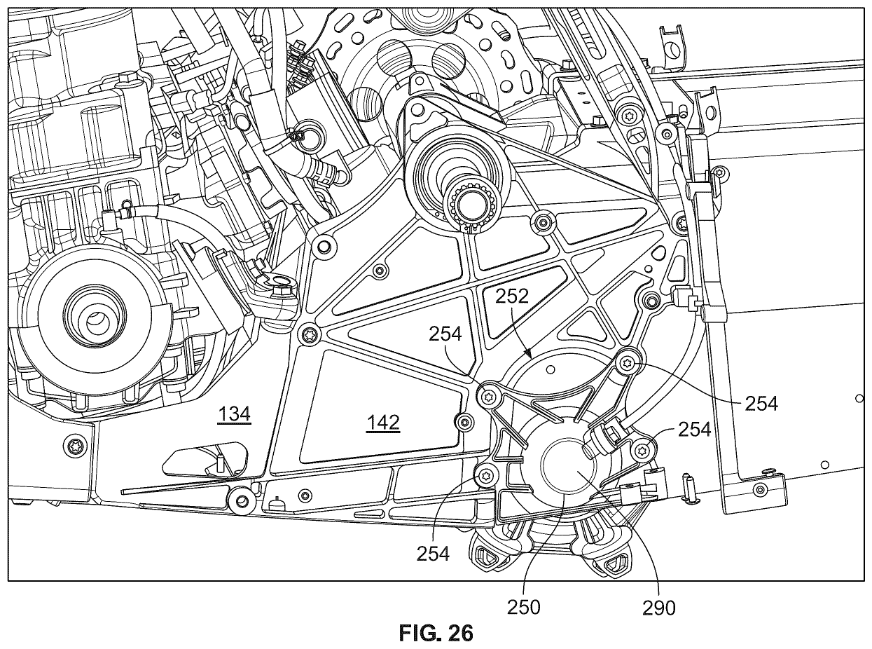

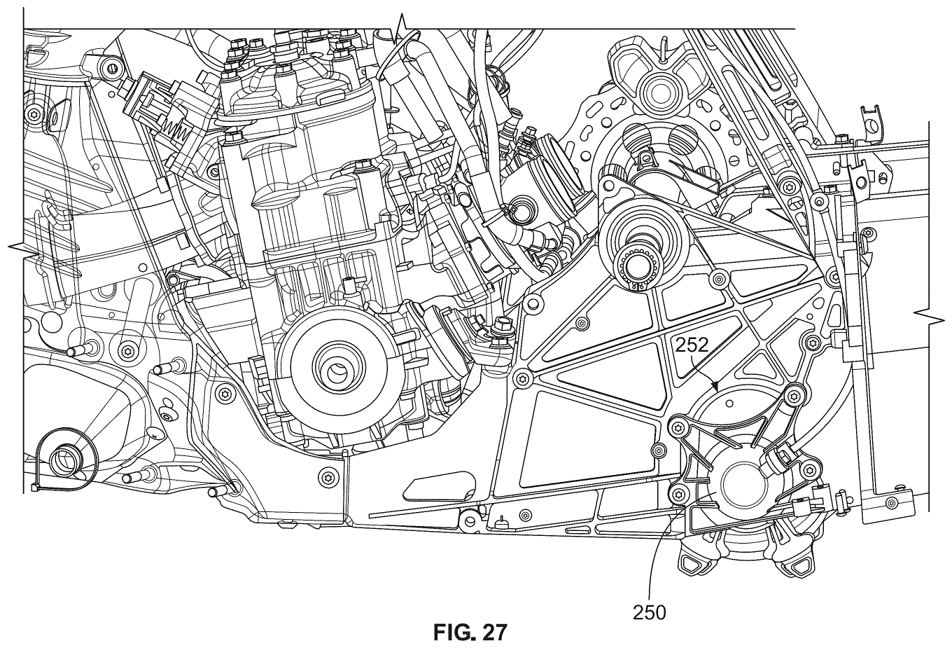

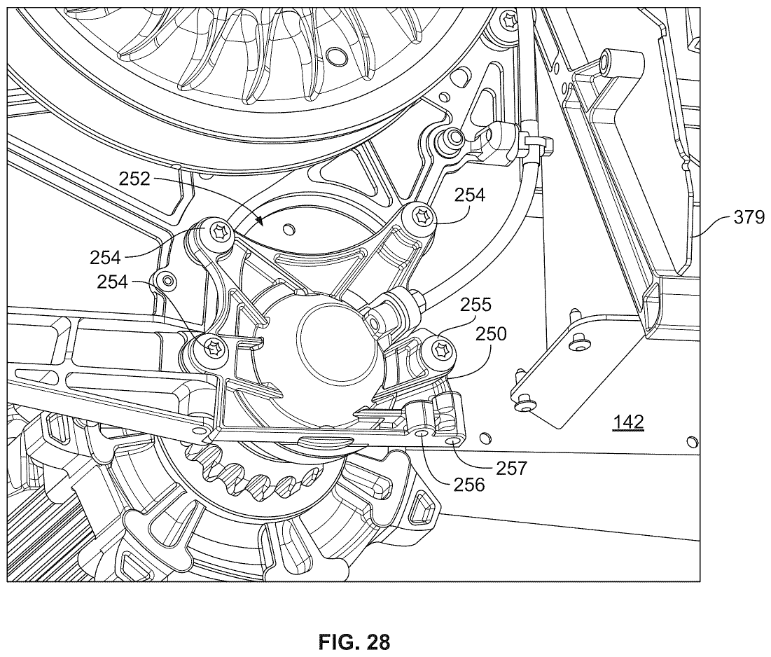

The chassis 120 has a construction adapted to facilitate installation, removal and/or replacement of the drive shaft 160. The chassis 120 includes a drive shaft mounting cover 250 that removably attaches to an outboard side of the left-side bulkhead plate 134 at a cover mounting location 252 (see FIGS. 26-28). The drive shaft mounting cover 250 can attach to the left-side bulkhead plate 134 via fasteners 254 (e.g., bolts) that extend in an outboard to inboard direction through the left-side bulkhead plate 134. The fasteners 254 can thread into tapped internally threaded openings defined by the left-side bulkhead plate 134. Fastener 255 (e.g., bolt) couples the drive shaft mounting cover 250 to the left side wall of the tunnel frame 138 and does not engage the left-side bulkhead plate 134. Additional fasteners that can be arranged in other orientations (e.g., a vertical orientation) can also be used to secure the drive shaft mounting cover 250 to other components (e.g., to a bracket, running board component, or other structure attached to the left wall 142 of the tunnel frame 138). For example, openings 256, 257 shown at FIG. 28 can be used for receiving vertical fasteners that can attach to a support bracket for a running board assembly.

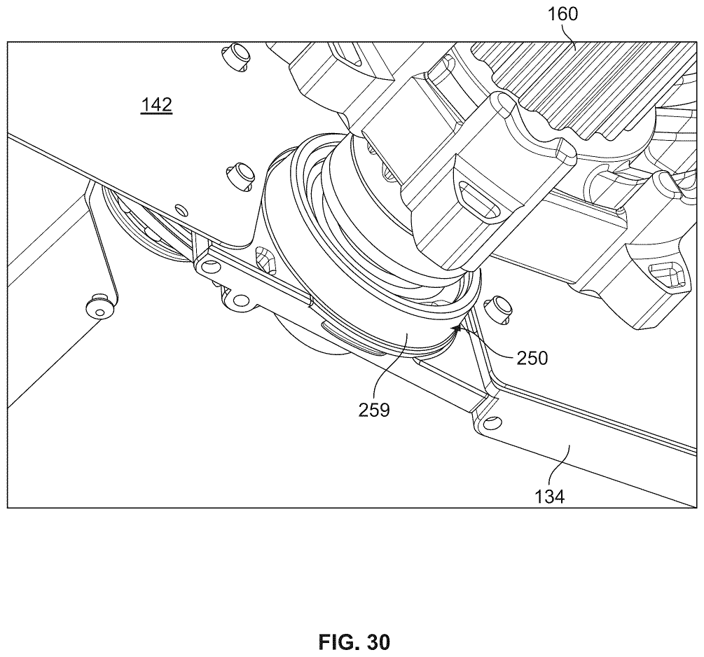

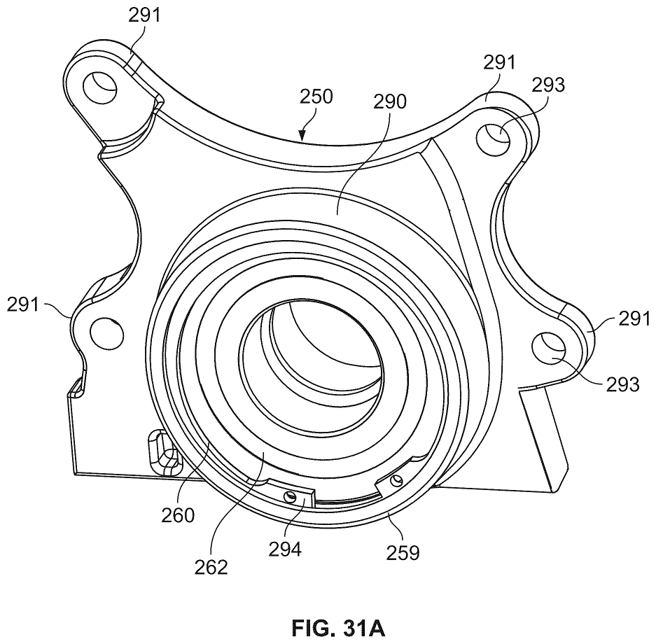

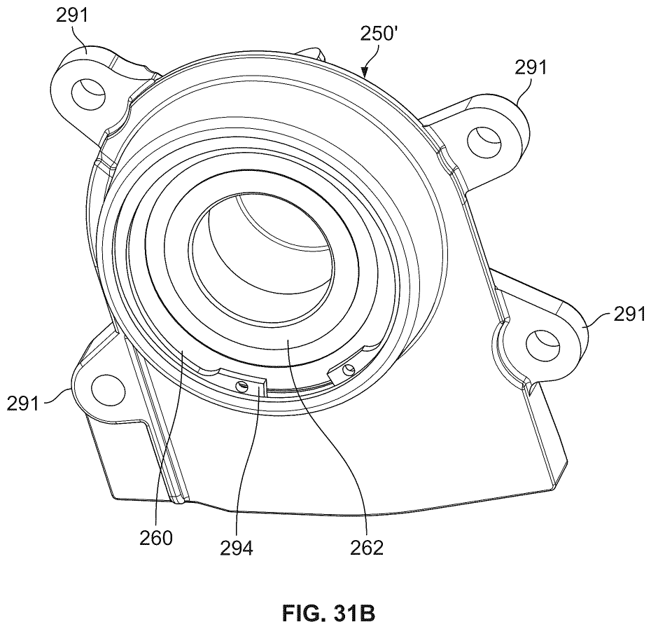

The left wall 142 of the tunnel frame 138 is attached to the inboard side of the left-side bulkhead plate 134. The left wall 142 defines a shaft opening 258 (e.g., a U-shaped opening) having a bottom side that is open. The shaft opening 258 aligns with the cover mounting location 252 of the left-side bulkhead plate 134. The drive shaft mounting cover 250 includes bearing receiving portion 259 (see FIGS. 30 and 31A) that protrudes through the shaft opening 258 when the drive shaft mounting cover 250 is attached to the outboard side of the left-side bulkhead plate 134. The drive shaft mounting cover 250 includes a central region 290 at which the bearing receiving portion 259 is located. The drive shaft mounting cover 250 also includes mounting projections 291 (e.g., arms, tabs, ears, etc.) that project outwardly from the central region 290. The mounting arms 291 define fastener openings 293 for receiving the fasteners 254.

The bearing receiving portion 259 of the drive shaft mounting cover 250 defines a third bearing pocket 260 in which a third bearing 262 is positioned. The third bearing pocket 260 has an open inboard side and a closed outboard side. A snap-ring 294 is used to retain the third bearing 262 axially within the third bearing pocket 260. The left-side bulkhead plate 134 defines a fourth bearing pocket 264 in which a fourth bearing 266 is positioned. Similar to the previously described bearings 204, 206, the third and fourth bearings 262, 266 can each include ball bearings positioned between inner and outer races. An elastomeric member such as a gasket can be provided radially between the outer race of the third bearing 262 and a cylindrical pocket-defining surface of the bearing receiving portion 259 to resist rotation of the outer race relative to the bearing receiving portion 259.

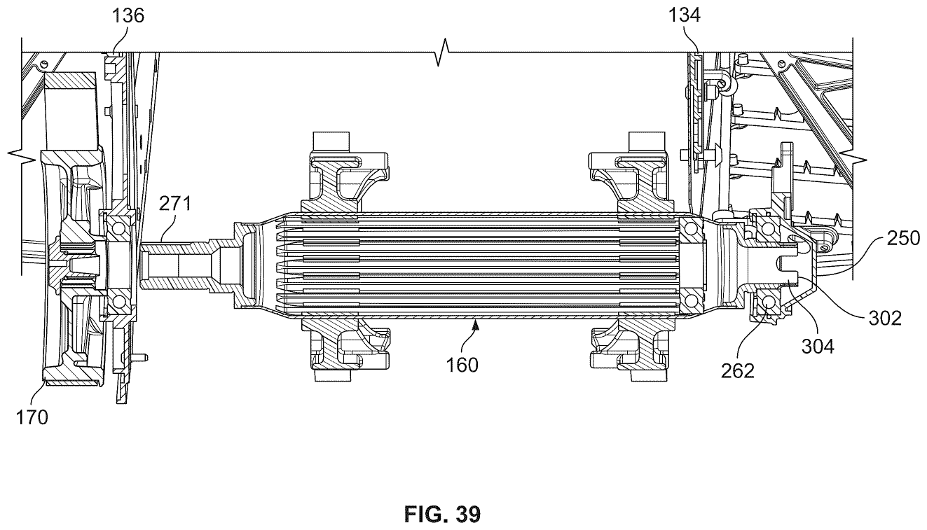

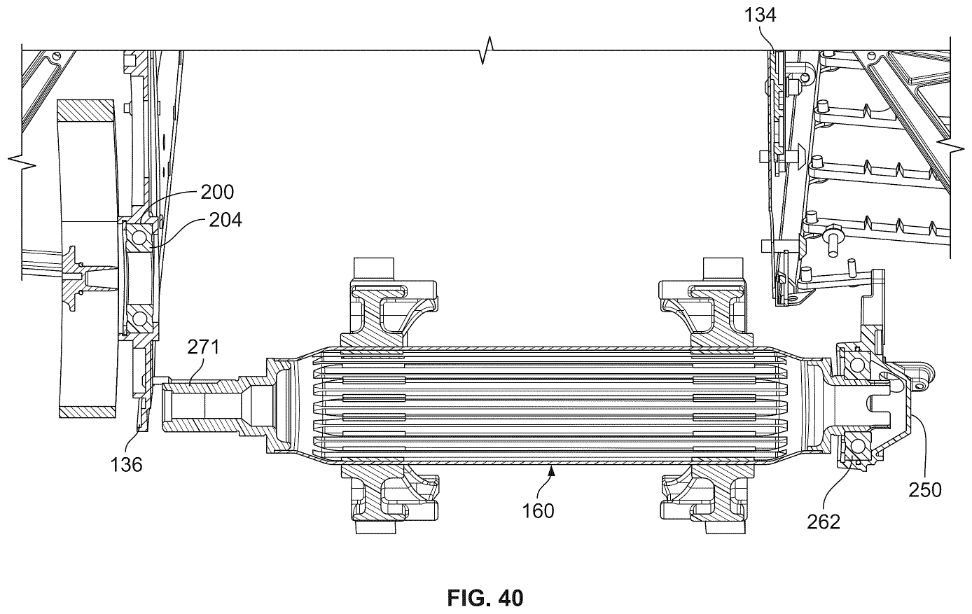

The drive shaft 160 extends across the width of the chassis and is supported for rotation about the drive shaft axis 162 by the first bearing 204 and the third bearing 262. The jack shaft 158 extends across the width of the chassis and is supported for rotation about the jack shaft axis 164 by the second bearing 206 and the fourth bearing 266. The left-side bulkhead plate 134 has an open configuration 268 beneath the cover mounting location 252 to facilitate removal of the drive shaft 160 from the interior of the interior tunnel region 139 without obstruction from the left-side bulkhead plate 134 by removing the drive shaft mounting cover 250 from the left-side bulkhead plate 134, sliding the drive shaft 160 axially in a leftward direction toward the left-side bulkhead plate 134 and then moving the drive shaft 160 downwardly from within the interior tunnel region 139. To allow the drive shaft 160 to be slid axially toward the left-side bulkhead plate 134, the end cap 207 thread into a first end 271 of the drive shaft 160 adjacent the first bearing 204 (see FIG. 38) can be removed thereby allowing the splined end of the drive shaft 160 to be disengaged from the sprocket 170 and slid through the first bearing 204. FIGS. 38-40 depict a sequence for removing the drive shaft 160 from the interior tunnel region 139. FIG. 38 shows the drive shaft 160 installed within the interior tunnel region 139. FIG. 39 shows the drive shaft mounting cover 250 disconnected from the left-side bulkhead plate 134, the end 207 disconnected from the first and 271 of the drive shaft 160, and the drive shaft 160 and drive shaft mounting cover 250 shifted toward the left-side bulkhead plate 134 such that the first end 271 of the drive shaft 160 is disengaged from the first bearing 204. In the position of FIG. 39, the chassis 120 does not interfere with downward movement of the drive shaft 160 or the drive shaft mounting cover 250 due to the U-shaped configuration of the shaft opening 258 of the left tunnel wall 142 and the open configuration 268 of the left-side bulkhead plate 134 beneath the cover mounting location 252. Thus, the drive shaft 160 and the drive shaft mounting cover 250 can be lowered to the position of FIG. 40 without obstruction from the chassis 120.

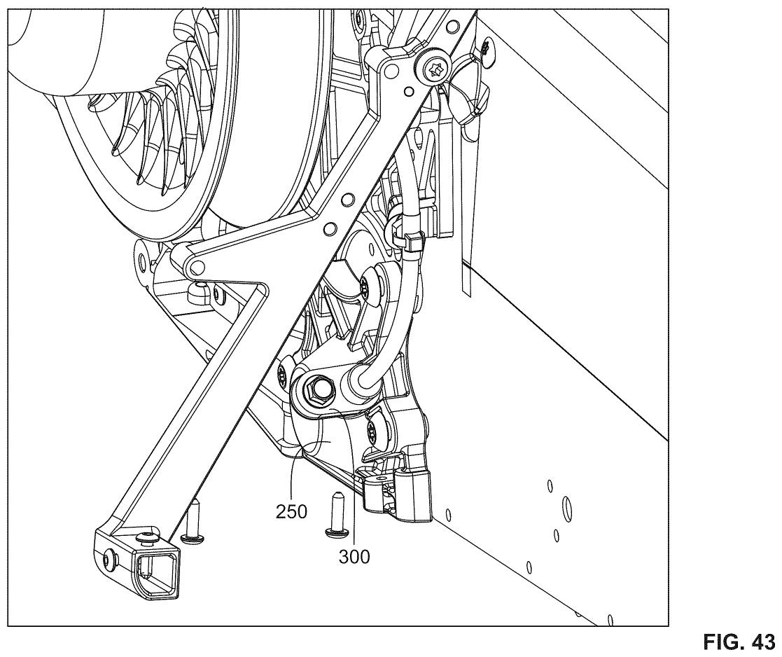

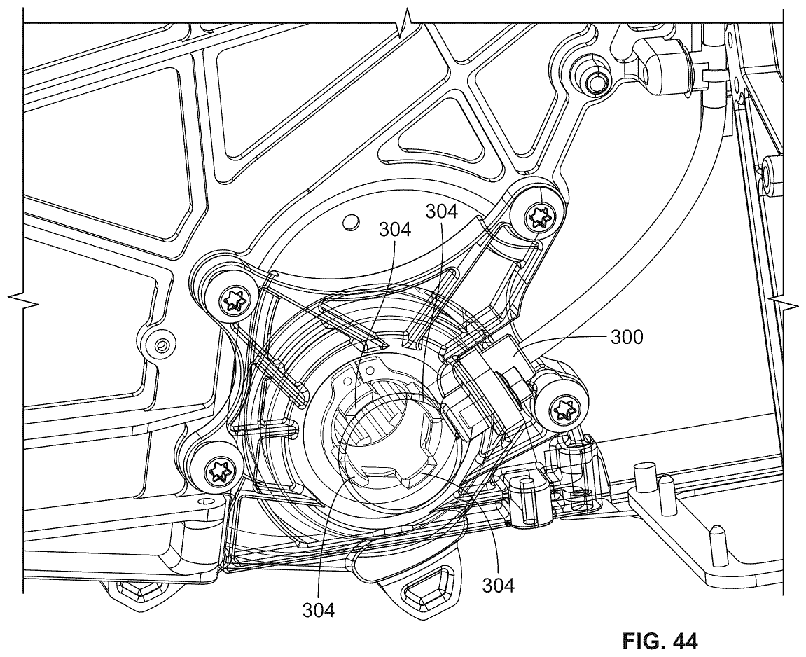

Referring to FIGS. 43 and 44, a speed sensor 300 is mounted to the drive shaft mounting cover 250 for sensing a rotational speed of the drive shaft 160 about the drive shaft axis 162. Data related to the rotational speed of the drive shaft 160 sensed by the speed sensor 300 can be used by an electronic controller to determine the speed of the snowmobile which can be displayed to the operator. A second end 302 of the drive shaft 160 is positioned within the drive shaft mounting cover 250 adjacent a closed end of the third bearing pocket 260. The second and 302 includes a plurality of integral rotation sensor pickups 304. The speed sensor 300 is configured to detect when each of the rotation sensor pickups 304 move past the sensor 300 as the drive shaft 160 rotates. Based on this sensed information relating to the pickups 304, the electronic controller can calculate a speed of the snowmobile. The rotation sensor pickups 304 are axial projections that are integral with the end of the drive shaft 160. The axial projections are circumferentially spaced about the drive shaft axis 162. In one example, the axial projections are arranged in a castellated configuration.

The drive shaft mounting cover 250 can be a custom part that is customized to provide a desired shaft spacing corresponding to a particular style of snowmobile (e.g., a mountain snowmobile). The drive shaft mounting cover 250 preferably has a cast construction. Hence, when the drive shaft running cover 250 is secured (e.g., fastened such as with fasteners such as bolts) to the left-side bulkhead plate 134, the centerline of the drive shaft 160 is precisely positioned relative to centerline of the jack shaft 158 and the centerline of the crankshaft 154. The drive shaft mounting cover 250 is customized to provide a centerline spacing between the jack shaft 158 and the drive shaft 160 that matches the jack shaft to drive shaft centerline spacing defined by the right-side bulkhead plate 136. For example, similar to the right-side bulkhead plate 136, the drive shaft mounting cover 250 is customized to provide the jack shaft to drive shaft centerline spacing corresponding to the first style of snowmobile (e.g., the mountain snowmobile). In one example, the drive shaft mounting cover 250 is one of a plurality of customized drive shaft mounting covers (e.g., cast drive shaft mounting covers) corresponding to different styles of snowmobiles. Each of the drive shaft mounting cover designs can provide a different jack shaft to drive shaft centerline spacing when coupled to the left-side bulkhead plate 134 and a different drive shaft to crankshaft centerline spacing when coupled to the left-side bulkhead plate 134. The different spacings can correspond to different styles of snowmobiles. In the depicted drive shaft mounting cover 250 of FIG. 31A can be used in combination with the left-side bulkhead plate 134 and the right-side bulkhead plate 136 to manufacture a chassis suitable for a mountain snowmobile. In contrast, an alternative drive shaft mounting cover 250′ (see FIG. 31B) can be used in combination with the left-side bulkhead mounting plate 134 and a customized right-side bulkhead mounting plate to manufacture a chassis suitable for a trail snowmobile. It will be appreciated that the left-side bulkhead mounting plate 134 is a modular part that can be shared between the chassis of different styles of snowmobile. In contrast, the drive shaft mounting covers are custom parts each customized to provide the desired drive shaft positioning corresponding to a particular style of snowmobile. In manufacturing, the manufacture can manufacture and stock left-side bulkhead mounting plates 134 they can be used to manufacture a variety of different snowmobile chassis, and can also manufacture and stock a number of different drive shaft mounting covers for use with the left-side bulkhead mounting plates 134 to allow for the manufacture of the different variety of snowmobile chassis while using a common left-side bulkhead mounting plate 134 between the different chassis designs. If it is desired to manufacture a mountain snowmobile, the drive shaft mounting plate 250 is selected for combination with the left-side bulkhead mounting plate 134. Alternatively, if it is desired to manufacture a trail snowmobile, the drive shaft mounting plate 250′ is selected for combination with the left-side bulkhead mounting plate 134. For the mountain snowmobile, the right-side bulkhead mounting plate 136 is selected for combination with the drive shaft mounting plate 250 and the left-side bulkhead mounting plate 134. For the trail snowmobile, an alternative right-side bulkhead and mounting plate 136′ is selected for combination with the drive shaft mounting plate 250′ and the left-side bulkhead mounting plate 134.

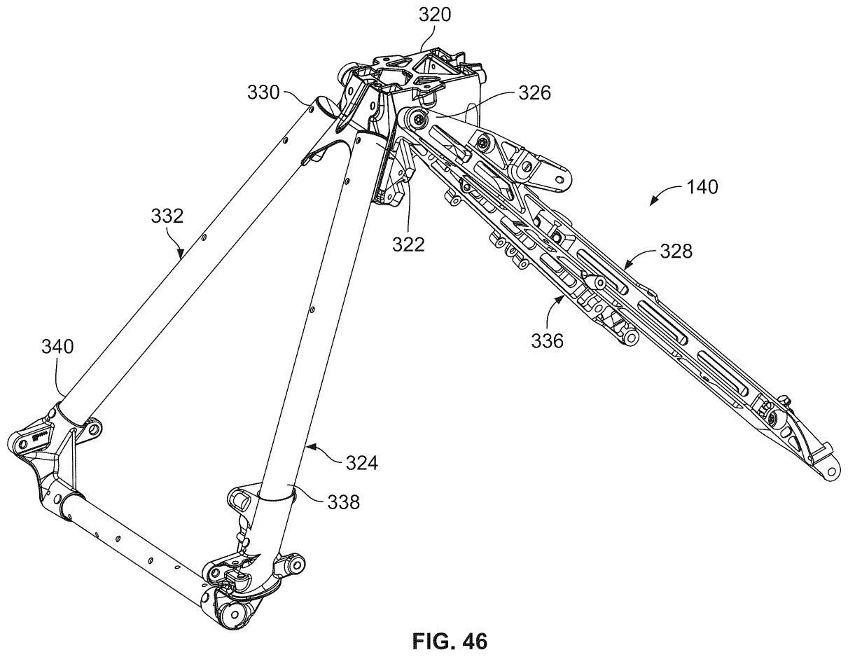

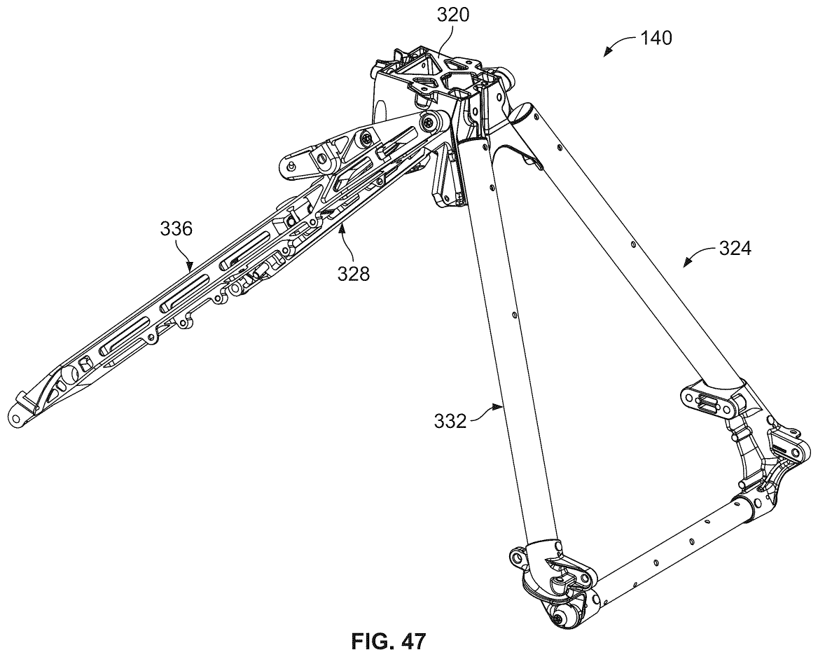

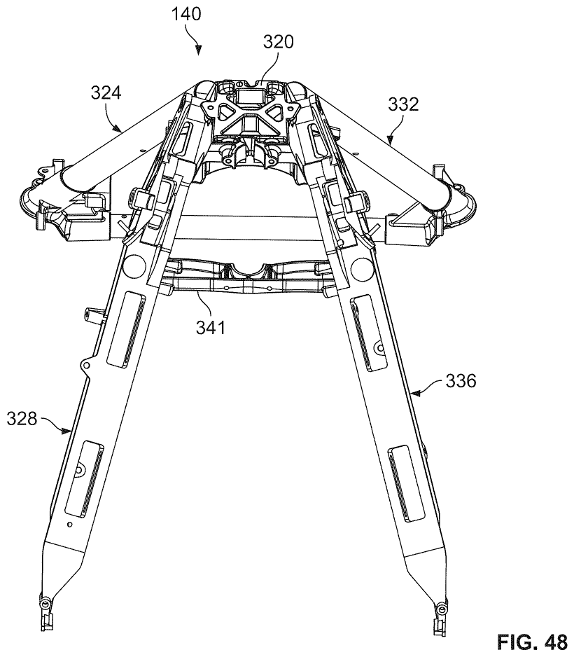

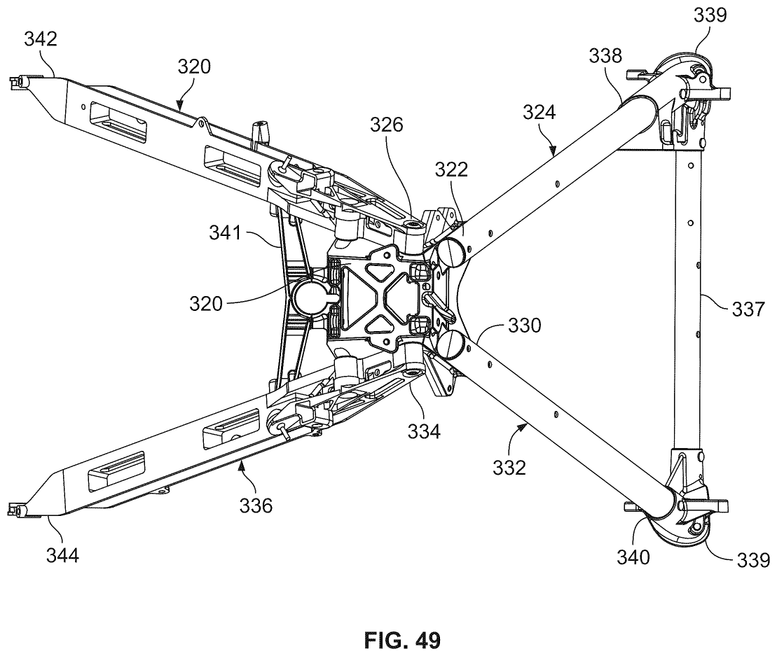

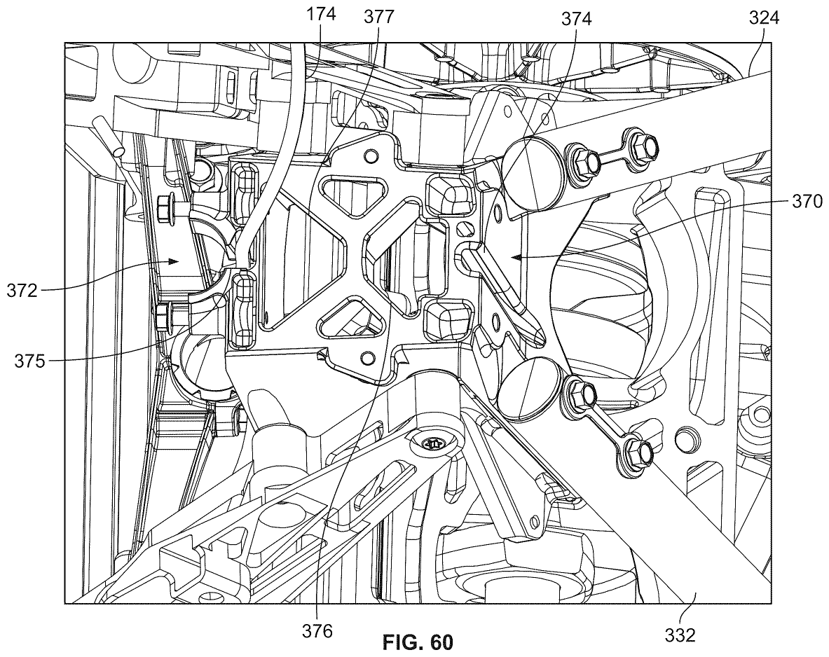

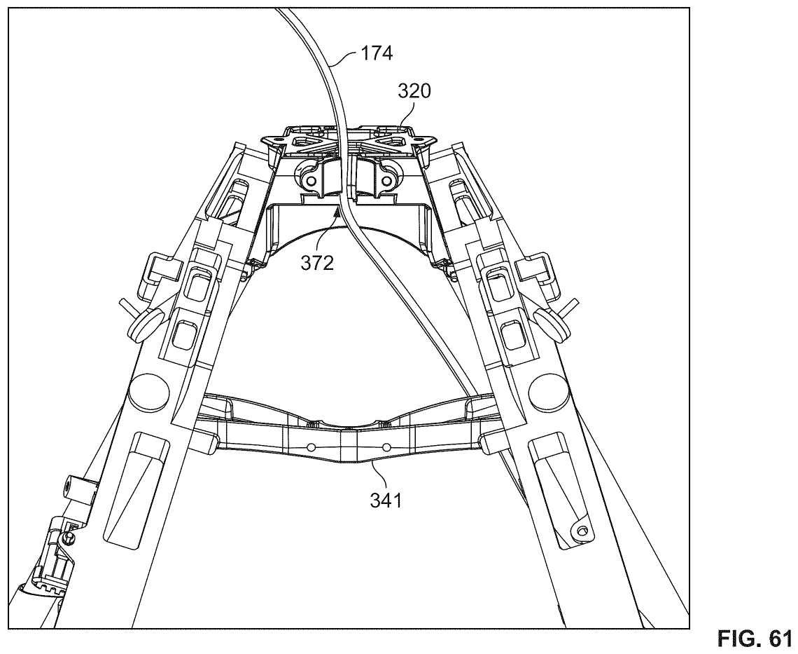

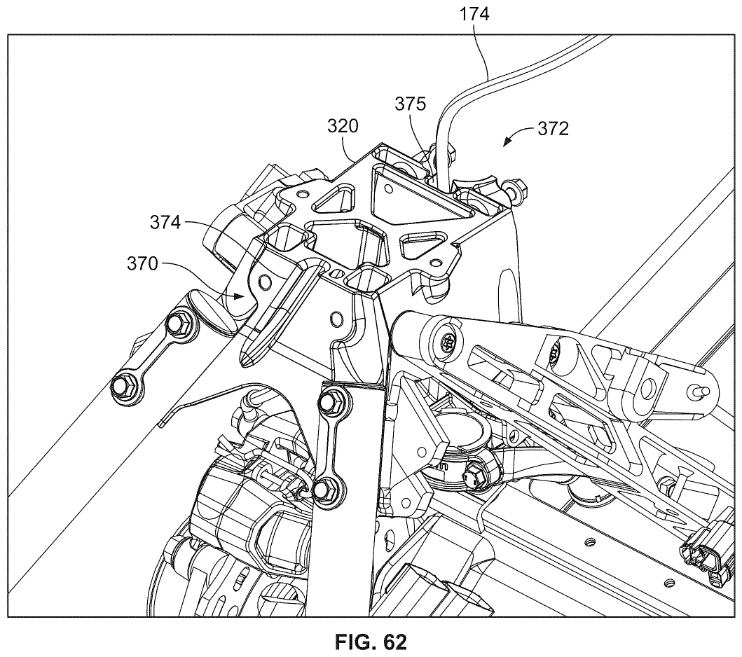

FIGS. 46-63 depict aspects of the over-structure 140 of the chassis 120. As best shown at FIGS. 46-49, the over-structure 140 includes an over-structure hub 320 defining an upper central portion of the over-structure 140. The over-structure hub 320 is configured for coupling together an upper end 322 of a left-front support member 324; an upper end 326 of a left-rear support member 328; an upper end 330 of a right-front support member 332; and an upper end 334 of a right-rear support member 336. The upper ends can be couple to the over-structure hub 320 by fasteners such as bolts that can thread into internally threaded openings defined by the over-structure hub 320. As shown at FIGS. 4, 5 and 9, a lower end 338 of the left-front support member 324 is coupled to the front suspension frame 132 adjacent the left side 128 of the chassis 120, and a lower end 340 of the right-front support member 332 is coupled to the front suspension frame 132 adjacent the right side 130 of the chassis 120. As shown at FIG. 14, a lower end 342 of the left-rear support member 328 is coupled to a rear end of the left-side bulkhead plate 134 and a lower end 344 of the right-rear support member 336 is coupled to a rear end of the right-side bulkhead plate 136. A cross-piece 337 (see FIG. 49) can extend across the width of the chassis between lower ends of the left-front support member 324 and the right-front support member 332. The cross-piece can have an extruded construction such as an extruded tube made of a material such as aluminum. The lower ends of the left-front support member 324 and the right-front support member 332 can be coupled to the cross-piece 337 by brackets 339 which also include fastening interfaces for connecting the lower ends to the front suspension frame 132. The over-structure hub 320 can include a cross-support 341 that connects between the left-rear support member 328 and the right-rear support member 336 to provide lateral support and can also provide steering shaft support. The over-structure 140 is configured to allow the same over-structure 140 to be used in different styles of snowmobiles (e.g., mountain snowmobiles and trail snowmobiles) to promote manufacturing efficiency by reducing the total number of different types of parts required to be stocked.

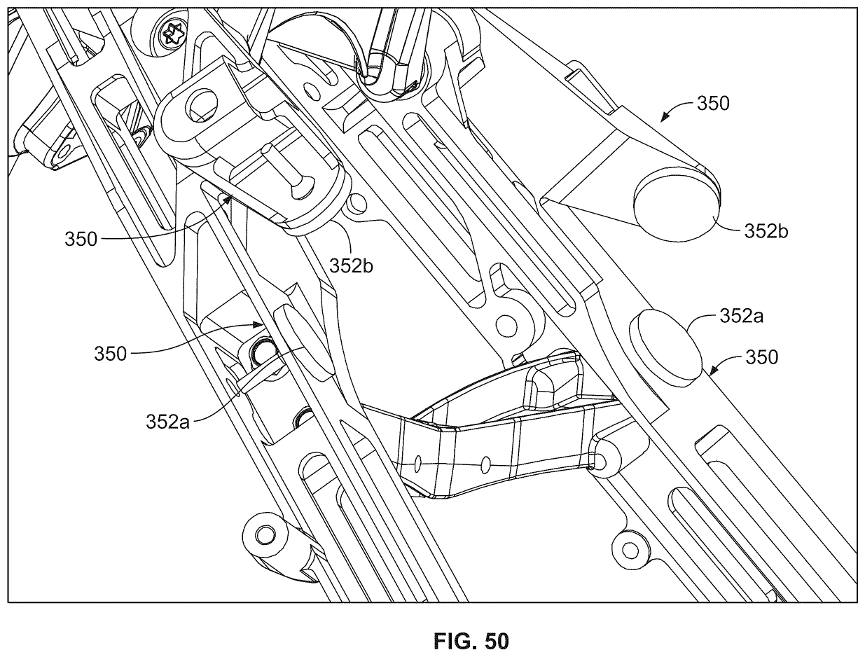

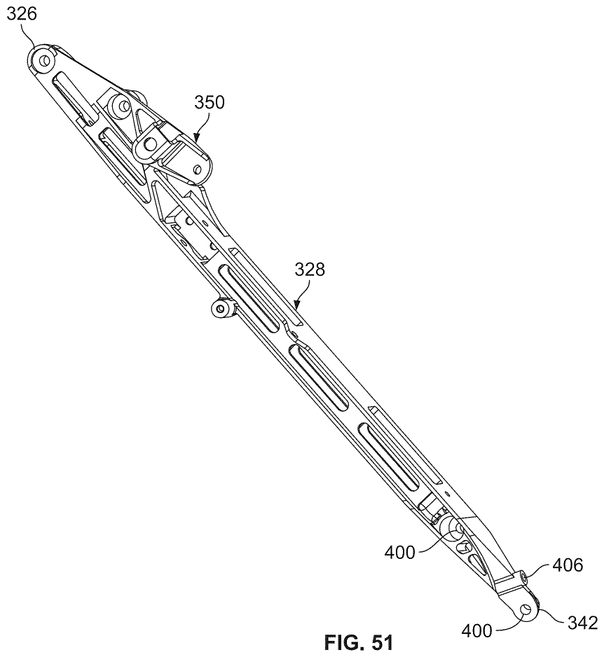

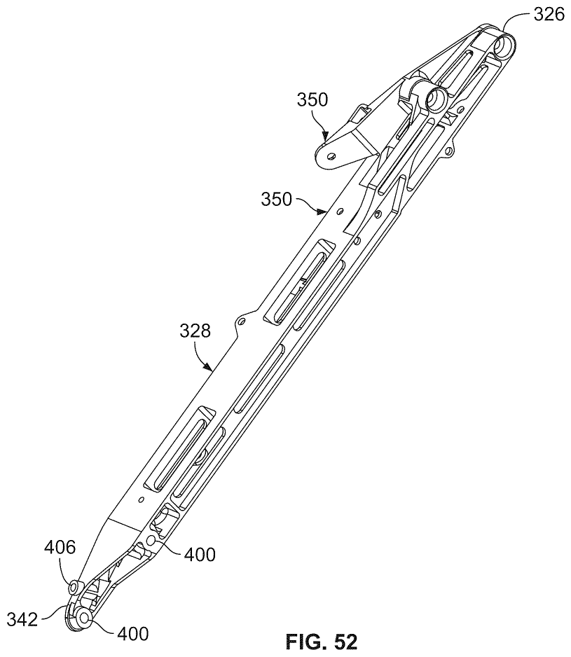

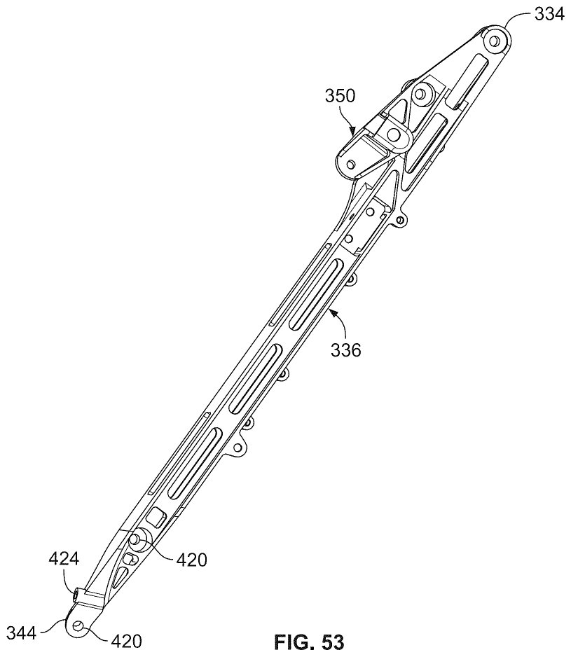

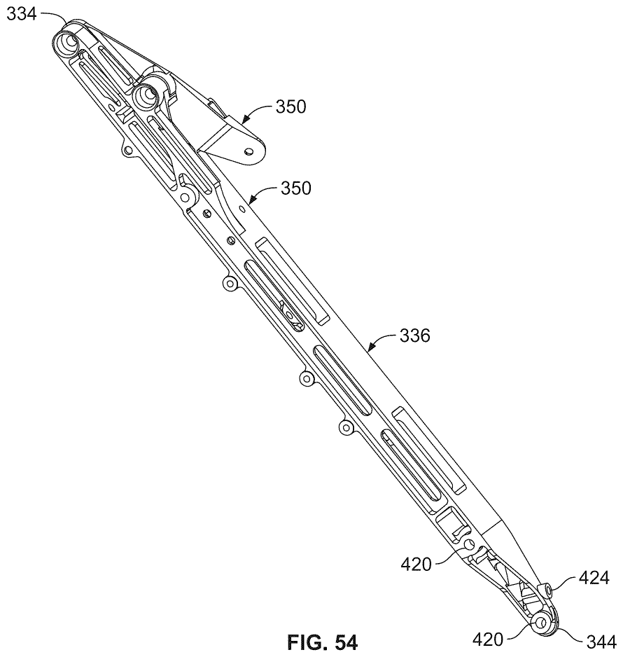

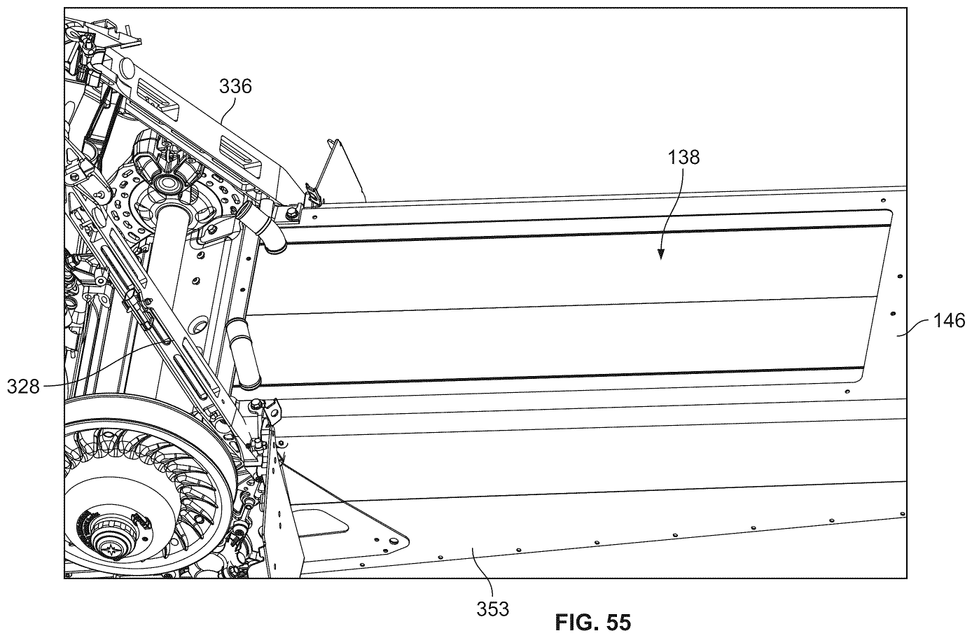

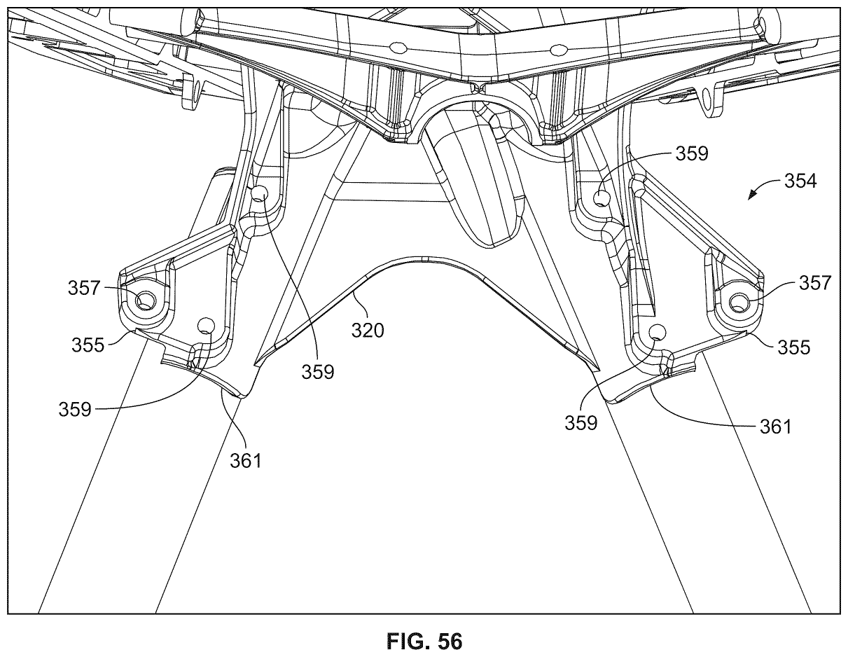

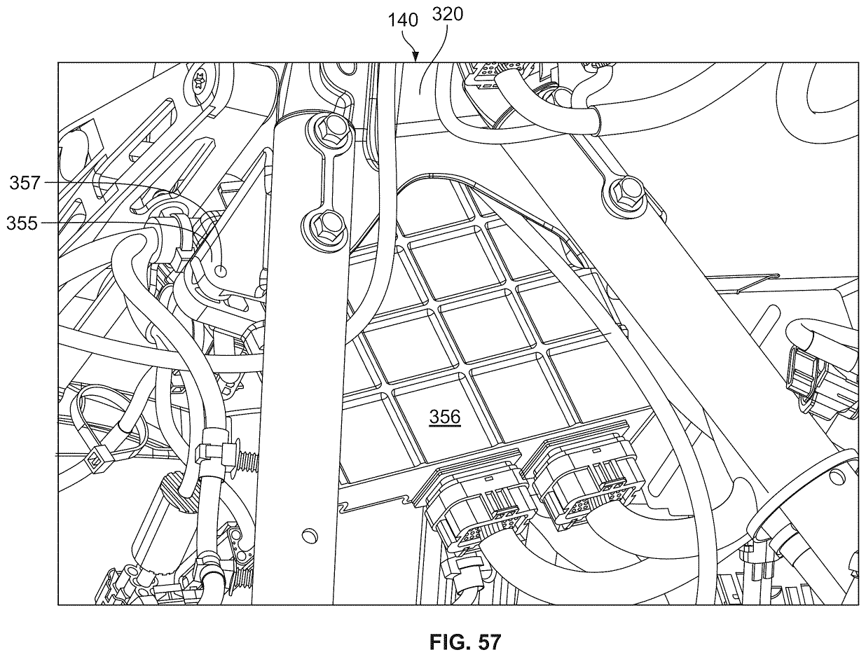

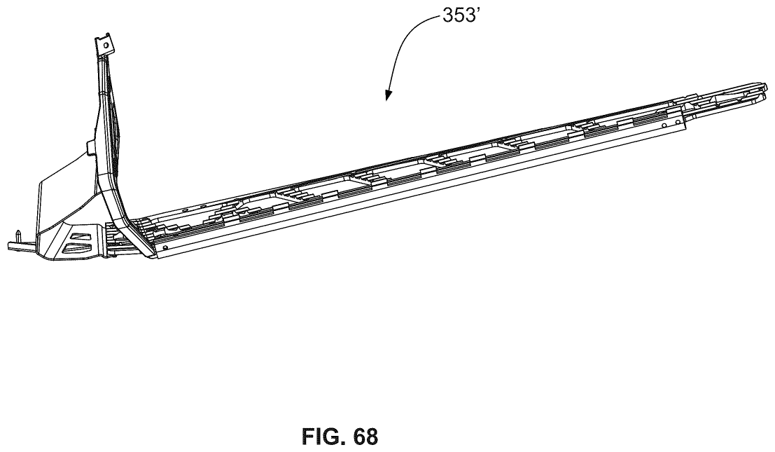

In the depicted example, the left-front support member 324 and the right-front support member 332 have an extruded construction such as an extruded aluminum construction (e.g., an extruded tube construction). In the depicted example, the over-structure hub 320, the left-rear support member 328 and the right-rear support member 336 have a cast construction such as a cast aluminum construction. By casting the over-structure hub 320, the left rear support member 328 and the right-rear support member 336, a variety of structures can be integrated into the structures to enhance modularity and functionality. FIGS. 51 and 52 depict the left-rear support member 328 and FIGS. 53 and 54 depicts the right-rear support member 336. FIG. 50 depicts fuel tank supports 350 including resilient pads that are integrated into the left-rear support member 328 and the right-rear support member 336. Lower pads 352a can support a front end of the fuel tank and side pads 352b can support sides of the fuel tank. As depicted at FIG. 55, lower ends of the right and left rear support members 336, 328 can attached to running board assemblies 353 at the sides of the chassis. For mountain style snowmobiles running board assemblies 353 having closed front foot receptacles can be attached to the lower ends of the support members 336, 328 while for trail style snowmobiles running board assemblies 353′ (as shown in FIG. 68) having open front foot receptacles can be attached to the lower ends of the support members 336, 328. FIGS. 56 and 57 depict an electronic controller mounting location 354 integrated into the underside of the over-structure hub 320. At the controller mounting location 354, the over-structure hub 320 includes ears 355 defining fastener openings 357 (internally threaded openings) positioned to mount a controller housing 356 (see FIG. 57) to the over-structure hub 320 with fasteners such as bolts. Fastener openings 359 (e.g., internally threaded fastener openings) and partial sleeves 361 defined by the over-structure hub 320 for attaching the upper ends of the left-front support member 324 and the right-front support member 332 to the over-structure bub 320 are also depicted at FIG. 56.

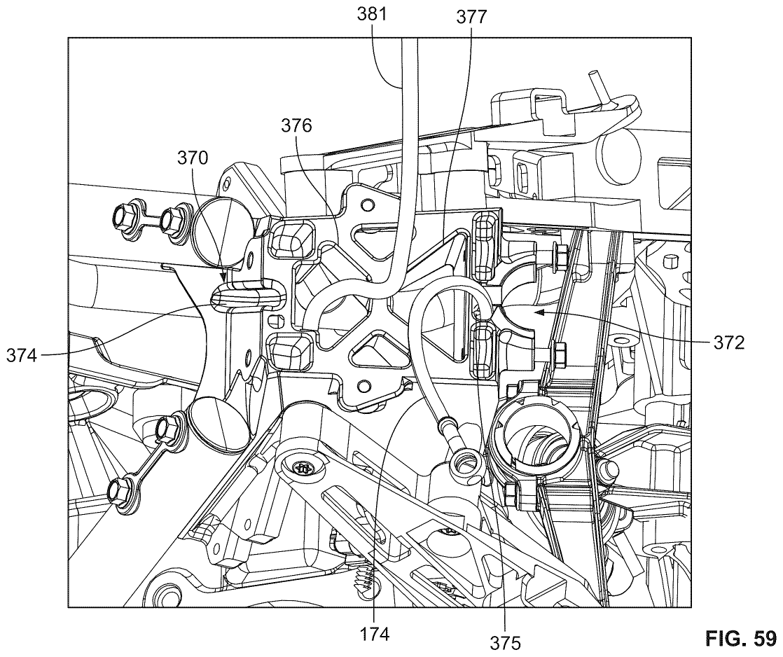

The over-structure hub 320 defines a front steering shaft mounting location 370 (see FIG. 63) for mounting a steering shaft 371 at a first angle relative to horizontal suitable for mountain style snowmobiles. The over-structure hub 320 also defines a rear steering shaft mounting location 372 (see FIG. 58) for mounting the steering shaft 371 at a second angle relative to horizontal that is less upright than the first angle and more suitable for trail style snowmobiles. The over-structure hub 320 defines a first brake line opening 374 located behind the front steering shaft mounting location 370 and a second brake line opening 375 located in front of the rear steering shaft mounting location 372. The over-structure hub 320 includes a throttle line opening 376 and a wire harness opening 377 in a region located between the first brake line opening 374 and the second brake line opening 375. FIG. 58 depicts a brake line 174 routed through the second brake line opening 375, a throttle line 381 routed through the throttle line opening 376 and a wire harness 382 routed through the wire harness opening 377. FIGS. 59-62 are various other views showing the brake line 174 routed through the second brake line opening 375 with the steering shaft 371 removed to enhance visibility. FIG. 63 depicts the brake line 174 routed through the first brake line opening 374 and the throttle line 381 routed through the throttle line opening 376. A handlebar 385 is shown coupled to the steering shaft 375.

The first brake line opening 374 has a forwardly facing open side that is enclosed by an assembly supporting the steering shaft 371 when the steering shaft 371 is mounted at the front steering shaft mounting location 370 (see FIG. 63) the second brake line opening 375 has a rear the facing open side that is enclosed by an assembly supporting the steering shaft 371 when the steering shaft 371 is mounted at the rear steering shaft mounting location 372 (see FIG. 58).

Aspects of the present disclosure relates to effectively using certain frame component designs as building blocks between different styles of snowmobiles to promote manufacturing efficiency. For example, in one embodiment, the design of the over-structure 140 and the design of the left-side bulkhead plate 134 can be shared between different styles of snowmobile such as mountain snowmobiles and trail snowmobiles. In manufacturing the different styles of snowmobiles, different custom frame components can be selected and combined with the modular frame components. For example, to manufacture a mountain snowmobile, the over-structure 140 and the left-side bulkhead plate 134 can be combined with the right-side bulkhead plate 136, the drive shaft mounting cover 250 and left and right running board assemblies 353 each having a front closed foot receptacle configuration. An example blocking plate 379 for use in closing off the front of a running board assembly is shown at FIG. 28. The front steering shaft mounting location 370 (see FIG. 63) allows the steering shaft 371 to be mounted in a more upright position while the over-structure 140 still accommodates steering line, brake line routing and harness routing while concurrently providing connection locations for the left and right running board assemblies having the closed front foot receptacle configurations. Additionally, the right-side bulkhead plate 136 in combination with the left-side bulkhead plate 134 with the drive shaft mounting cover 250 provides a relatively low positioning of the drive shaft 160 relative to the jack shaft 158 suitable for mountain snowmobiles. To manufacture a trail snowmobile, the over-structure 140 and the left-side bulkhead plate 134 can be combined with a modified right-side bulkhead plate 136′, the drive shaft mounting cover 250′ and left and right running board assemblies 353′ each having an open front foot receptacle. The rear steering shaft mounting location 372 (see FIG. 58) allows the steering shaft 371 to be mounted in a more reclined position while the over-structure 140 still accommodates steering line, brake line routing and harness routing while concurrently providing connection locations for the left and right running board assemblies having the open front foot receptacle configurations. Additionally, the modified right-side bulkhead plate in combination with the left-side bulkhead plate 134 with the drive shaft mounting cover 250′ provides a higher positioning of the drive shaft 160 relative to the jack shaft 158 suitable for trail snowmobiles. In both snowmobile styles, the over-structure 140 can provide for electronic controller mounting and fuel tank support. It will be appreciated that mountain and trail snowmobiles typically have different tunnel frame configurations. The depicted tunnel frame 138 is adapted for a mountain snowmobile. In contrast, a tunnel frame for a trail snowmobile can be shorter and can have a different slot configuration adjacent the cover mounting location 252 of the left-side bulkhead plate 134 that is suitable to accommodate the drive shaft mounting cover 250′.

It will be appreciated that certain of the fastener openings defined by the left-side bulkhead plate 134 and the right-side bulkhead plate 136 can be internally threaded (e.g., tapped) to be configured to threadingly engage with exterior threads of fasteners such as bolts.

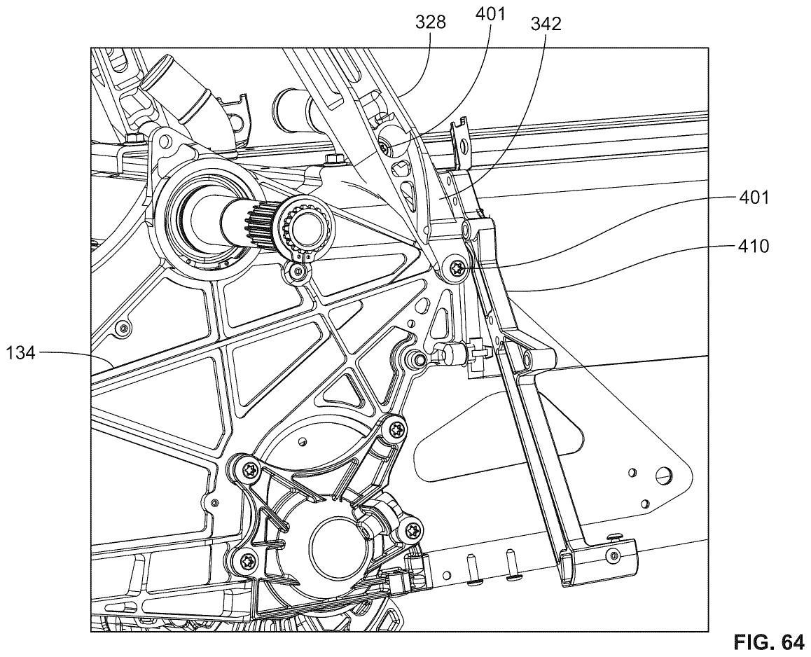

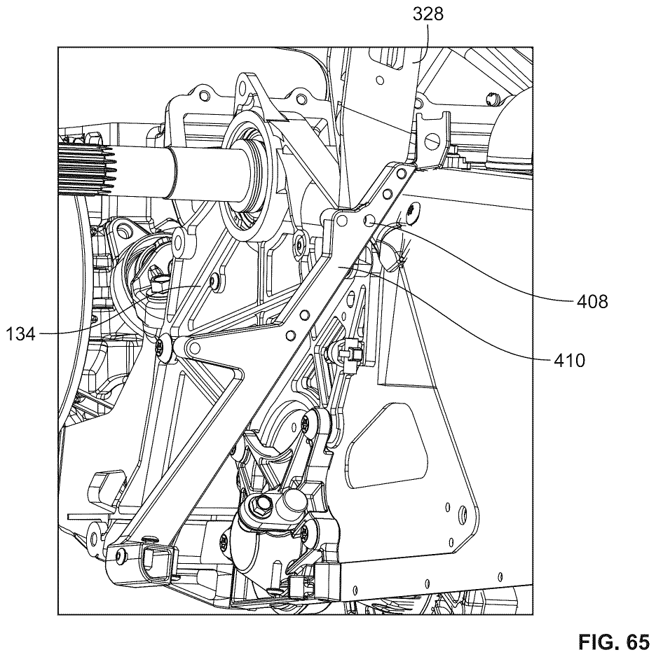

It will be appreciated that the lower end of the left-rear support member 328 is configured to provide multiple mechanical attachment locations. The attachment locations can be configured for providing a connection to the rear end of the left-side bulkhead plate 134 and for providing at least one connection to a left-side running board assembly. The connection location for the left-side running board assembly is compatible with multiple styles/types of running board assemblies (e.g., mountain snowmobile style, trail snowmobile style, cross-over snowmobile style, etc.). The connection location of the lower end of the left-rear support member 328 to the rear end of the left-side bulkhead plate 134 is provided by fasteners openings 400 (see FIGS. 51 and 52) for receiving fasteners such as bolts 401 that can be threaded into fastener openings 402 (see FIGS. 32 and 64) adjacent the rear end of the left-side bulkhead plate 134. The connection location with respect to the left-side running board assembly is provided by fastener opening 406 (see FIGS. 51 and 52) oriented generally transversely relative to the fastener openings 400. The fastener opening 406 is configured for receiving a fastener such as a bolt that can be threaded into the fastener opening 406 and passed through a fastener opening 408 of a running board mounting bracket 410 (see FIG. 65) of a running board assembly to secure the running board mounting bracket 410 to the left-rear support member 328. The running board mounting bracket 410 can be configured for use in secure a first type of left-side running board assembly (e.g., a mountain snowmobile style running board assembly) to the left-rear support member 328. It will be appreciated that different running board mounting bracket designs corresponding to different styles of running board assemblies (e.g., trail snowmobile style running board assemblies) can be configured for attachment at the fastener opening 406 to allow for different styles of left-side running boards assemblies to be attached to the left-rear support member 328.

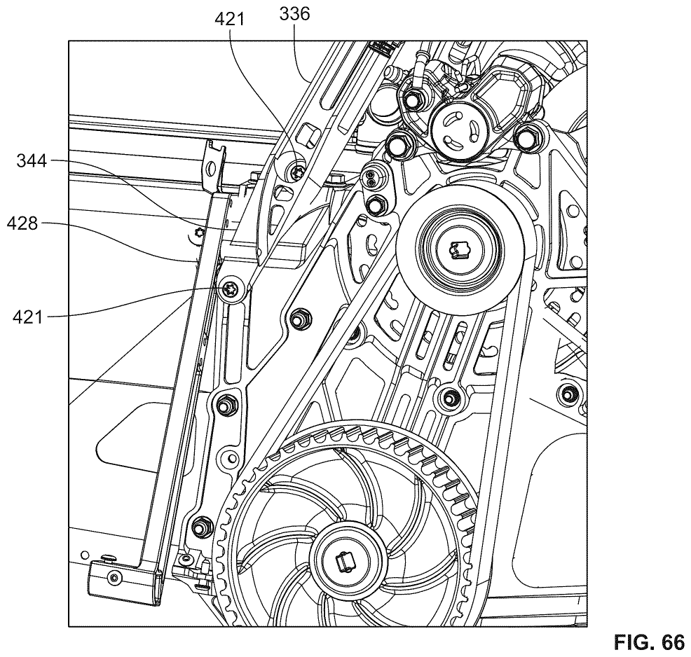

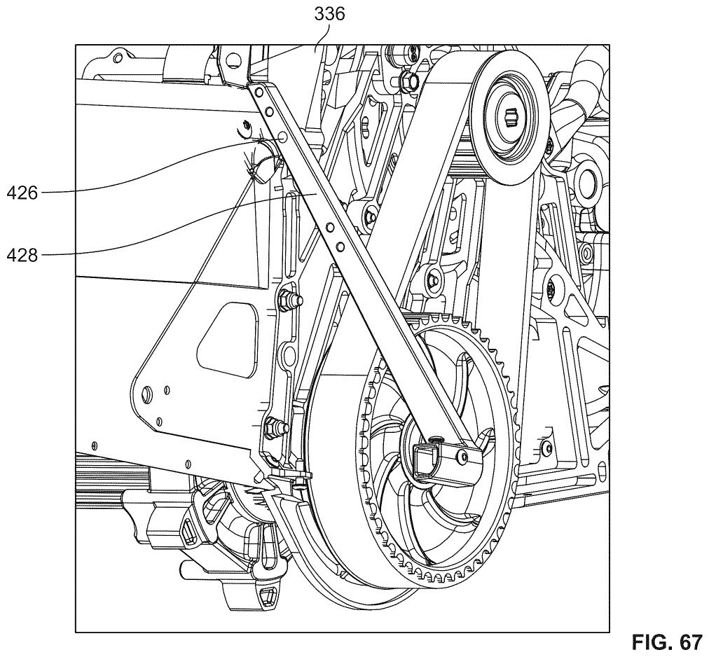

It will be appreciated that the lower end of the right-rear support member 336 is configured to provide multiple mechanical attachment locations. The attachment locations can be configured for providing a connection to the rear end of the right-side bulkhead plate 136 and for providing at least one connection to a right-side running board assembly. The connection location for the right-side running board assembly is compatible with multiple styles/types of running board assemblies (e.g., mountain snowmobile style, trail snowmobile style, cross-over snowmobile style, etc.). The connection location of the lower end of the right-rear support member 336 to the rear end of the right-side bulkhead plate 136 is provided by fasteners openings 420 (see FIGS. 53 and 54) for receiving fasteners such as bolts 421 that can be threaded into fastener openings 422 (see FIGS. 18 and 66) adjacent the rear end of the right-side bulkhead plate 136. The connection location with respect to the right-side running board assembly is provided by fastener opening 424 (see FIGS. 53 and 54) oriented generally transversely relative to the fastener openings 420. The fastener opening 424 is configured for receiving a fastener such as a bolt that can be threaded into the fastener opening 424 and passed through a fastener opening 426 of a running board mounting bracket 428 (see FIG. 67) of a running board assembly to secure the running board mounting bracket 428 to the right-rear support member 336. The running board mounting bracket 428 can be configured for use in secure a first type of right-side running board assembly (e.g., a mountain snowmobile style running board assembly such as running board 353) to the right-rear support member 336. It will be appreciated that different running board mounting bracket designs corresponding to different styles of running board assemblies (e.g., trail snowmobile style running board assemblies such as running board 353′) can be configured for attachment at the fastener opening 424 to allow for different styles of right-side running boards assemblies to be attached to the right-rear support member 336.

The various examples described above are provided by way of illustration only and should not be construed to limit the scope of the present disclosure. Those skilled in the art will readily recognize various modifications and changes that may be made without following the example examples and applications illustrated and described herein, and without departing from the true spirit and scope of the present disclosure.

1-68. (canceled)

69. A snowmobile comprising:
a tunnel frame defining an interior tunnel region;
a track positioned at least partially within the interior tunnel region;
a drive shaft that interfaces with the track to drive rotation of the track relative to the tunnel frame, the drive shaft being rotatable about a drive shaft axis;
a jack shaft rotatable about a jack shaft axis;
a drive element for transferring torque from the jack shaft to the drive shaft for driving rotation of the drive shaft about the drive shaft axis;
an engine including a crankshaft;
a transmission for transferring torque from the crankshaft to the jack shaft;
a side bulkhead plate connected to the tunnel frame; and
a drive shaft mounting cover that removably attaches to the side bulkhead plate at a cover mounting location, the drive shaft mounting cover defining a bearing pocket in which a bearing is positioned, the drive shaft extending across a width of the snowmobile and being supported for rotation about the drive shaft axis by the bearing.

70. The snowmobile of claim 69, wherein the side bulkhead plate and the drive shaft mounting cover are cast parts, and wherein the drive shaft mounting cover is bolted to the side bulkhead plate at the cover mounting location.

71. The snowmobile of claim 69, wherein the drive shaft mounting cover is bolted to the side bulkhead plate at the cover mounting location.

72. The snowmobile of claim 69, wherein the side bulkhead plate has an open configuration beneath the cover mounting location to facilitate removal of the drive shaft from the interior tunnel region without obstruction from the side bulkhead plate by removing the drive shaft mounting cover from the side bulkhead plate, sliding the drive shaft axially toward the side bulkhead plate and then moving the drive shaft downwardly from within the interior tunnel region.

73. The snowmobile of claim 72, wherein the tunnel frame includes a side wall that at attaches to an inboard side of the side bulkhead plate, and wherein the side wall defines a U-shaped opening at the cover mounting through which an inboard portion of the drive shaft mounting cover extends, the U-shaped opening having an open lower end.

74. The snowmobile of claim 69, wherein the drive shaft mounting cover is a first drive shaft mounting cover, wherein a second drive shaft mounting cover is mountable at the cover mounting location in place of the first drive shaft mounting cover, and wherein the first and second drive shaft mounting covers are adapted to position the drive shaft axis at different locations with respect to the side bulkhead plate.

75. The snowmobile of claim 74, further comprising a second side bulkhead plate, the second side bulkhead plate including a second bearing pocket in which a second bearing is received and a third bearing pocket in which a third bearing is received, the second bearing pocket supporting the drive shaft and the third bearing supporting the jack shaft,
wherein the second side bulkhead plate has a configuration selected from a first configuration where the second bearing pocket is positioned such that the second bearing supports the drive shaft when the drive shaft mounting cover is the first drive shaft mounting cover, or a second configuration where the second bearing pocket is positioned such that the second bearing supports the drive shaft when the drive shaft mounting cover is the first drive shaft mounting cover.

76. The snowmobile of claim 75, wherein the second side bulkhead plate is a cast part.

77. A snowmobile comprising:
a tunnel frame defining an interior tunnel region;
a track positioned at least partially within the interior tunnel region;
a drive shaft that interfaces with the track to drive rotation of the track relative to the tunnel frame, the drive shaft being rotatable about a drive shaft axis;
a jack shaft rotatable about a jack shaft axis;
a drive element for transferring torque from the jack shaft to the drive shaft for driving rotation of the drive shaft about the drive shaft axis;
an engine including a crankshaft;
a transmission for transferring torque from the crankshaft to the jack shaft;
a side bulkhead plate connected to tunnel frame, the side bulkhead plate having a one-piece cast construction, the side bulkhead plate defining a first bearing pocket and a second bearing pocket;
a first bearing positioned in the first bearing pocket, the first bearing supporting the drive shaft for rotation about the drive shaft axis;
a second bearing positioned in the second bearing pocket, the second bearing supporting the jack shaft for rotation about the jack shaft axis.

78. The snowmobile of claim 77, wherein the drive shaft, the jack shaft and the crankshaft are generally parallel and arranged in a triangular configuration from a side view of the snowmobile.

79. The snowmobile of claim 78, wherein the tunnel frame includes a heat exchanger for cooling engine coolant used to cool the engine, wherein the heat exchanger includes an integral mounting projection, and wherein an engine mount coupled to the engine is clamped between the side bulkhead plate and the mounting projection.

80. The snowmobile of claim 79, further comprising at least two parallel fasteners that are tightened to clamp the engine mount between the side bulkhead plate and the mounting projection.

81. The snowmobile of claim 80, wherein the fasteners are bolts that extend through the side bulkhead plate, the engine mount, and the mounting projection.

82. The snowmobile of claim 77, wherein the side bulkhead plate has a one-piece cast construction.

83. A snowmobile comprising:
a tunnel frame defining an interior tunnel region;
a track positioned at least partially within the interior tunnel region;
a drive shaft that interfaces with the track to drive rotation of the track relative to the tunnel frame, the drive shaft being rotatable about a drive shaft axis;
a jack shaft rotatable about a jack shaft axis;
a drive element for transferring torque from the jack shaft to the drive shaft for driving rotation of the drive shaft about the drive shaft axis;
a brake system including a caliper and a braking disc, the braking disc being rotatable with the jack shaft about the jack shaft axis; and
a side bulkhead supporting the jack shaft,
wherein the drive element is outboard with respect to the side bulkhead, and wherein the braking disc is inboard with respect to the side bulkhead,
wherein the side bulkhead includes one or more shielding elements positioned between the drive element and the braking disc for shielding the drive element from heat generated at the braking disc.

84. The snowmobile of claim 83, wherein the drive element is a belt.

85. The snowmobile of claim 83, wherein the side bulkhead includes a plurality of openings positioned offset with respect to the drive element.

86. The snowmobile of claim 85, wherein the one more shielding elements include a first shielding element and a second shielding element, and at least some of the plurality of openings are provided between the first shielding element and the second shielding element.

87. The snowmobile of claim 86, wherein the first shielding element and the second shielding element are each respectively aligned with corresponding portions of the drive element.

88. The snowmobile of claim 83, wherein the side bulkhead includes a first bearing pocket in which a first bearing is positioned and a second bearing pocket in which a second bearing is positioned, the first bearing supporting the drive shaft and the second bearing supporting the jack shaft, wherein the one or more shielding elements surround the first bearing pocket and the second bearing pocket.

89. The snowmobile of claim 83, wherein the braking disc is exposed to the interior tunnel region.
